(19) United States
(12) Patent Application Publication
(10) Pub. No.: US 2021/0110265 A1
(43) Pub. Date: Apr. 15, 2021

(54) METHODS AND APPARATUS TO COMPRESS WEIGHTS OF AN ARTIFICIAL INTELLIGENCE MODEL

(71) Applicant: Intel Corporation, Santa Clara, CA (US)

(72) Inventors: Palanivel Guruva reddiar, Chandler, AZ (US); Praveen Nair, Chandler, AZ (US)

(21) Appl. No.: 17/131,391

(22) Filed: Dec. 22, 2020

(51) Int. Cl. G06N 3/08; G06N 3/04

(52) U.S. Cl. CPC G06N 3/08; G06N 3/04

(57) ABSTRACT

Methods, apparatus, systems, and articles of manufacture to compress weights of an artificial intelligence model are disclosed. An example apparatus includes a channel manipulator to manipulate weights of a channel of a trained model to generate a manipulated channel; a comparator to determine a similarity between (a) at least one of the channel or the manipulated channel and (b) a reference channel; and a data packet generator to, when the similarity satisfies a similarity threshold, generate a compressed data packet based on a difference between (a) the at least one of the channel or the manipulated channel and (b) the reference channel.

### FIELD OF THE DISCLOSURE

This disclosure relates generally to machine learning, and, more particularly, to methods and apparatus to compress weights of an artificial intelligence model.

### BACKGROUND

In recent years, machine learning and/or artificial intelligence have increased in popularity. For example, machine learning and/or artificial intelligence may be implemented using neural networks. Neural networks are computing systems inspired by the neural networks of human brains. A neural network can receive an input and generate an output. The neural network can be trained (e.g., can learn) based on feedback so that the output corresponds to a desired result. Once trained, the neural network can make decisions to generate an output based on any input. In some examples, the weights of a neural network are trained and/or determined at a first device (e.g., a server, a datacenter, etc.) and deployed to a second device to be implemented in a model at the second device. Neural networks are used for the emerging fields of artificial intelligence and/or machine learning.

### BRIEF DESCRIPTION OF THE DRAWINGS

FIG. 1 is a schematic illustration of an example server to train a neural network and compress the weights of the trained neural network.

FIG. 2 is a block diagram of an example weight compressor of the server of FIG. 1.

FIG. 3 is a block diagram of an example weight decompressor of the internet of things device of FIG. 1.

FIG. 4 is a flowchart representative of example machine readable instructions which may be executed to implement the example weight compressor of FIGS. 1 and/or 2 to compress weights of a neural network.

FIG. 5 is a flowchart representative of example machine readable instructions which may be executed to implement the example weight decompressor of FIGS. 1 and/or 3 to decompress weights to be implemented in a neural network.

FIG. 6 illustrates a weight that can be compressed based on a reference weight and a data packet representing the compression.

FIG. 7 illustrates an overview of an edge cloud configuration for edge computing.

FIG. 8 illustrates operational layers among endpoints, an edge cloud, and cloud computing environments.

FIG. 9 illustrates an example approach for networking and services in an edge computing system.

FIG. 10 is a block diagram of an example processing platform structured to execute the instructions of FIG. 4 to implement the example weight compressor of FIGS. 1 and/or 2.

FIG. 11 is a block diagram of an example processing platform structured to execute the instructions of FIG. 5 to implement the example weight decompressor of FIGS. 1 and/or 3.

FIG. 12A provides an overview of example components for compute deployed at a compute node in an edge computing system.

FIG. 12B provides a further overview of example components within a computing device in an edge computing system.

FIG. 13 illustrates an example software distribution platform.

The figures are not to scale. In general, the same reference numbers will be used throughout the drawing(s) and accompanying written description to refer to the same or like parts. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. Although the figures show layers and regions with clean lines and boundaries, some or all of these lines and/or boundaries may be idealized. In reality, the boundaries and/or lines may be unobservable, blended, and/or irregular.

Descriptors “first,” “second,” “third,” etc. are used herein when identifying multiple elements or components which may be referred to separately. Unless otherwise specified or understood based on their context of use, such descriptors are not intended to impute any meaning of priority, physical order or arrangement in a list, or ordering in time but are merely used as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

### DETAILED DESCRIPTION

Machine learning models, such as neural networks, are used to be able to perform a task (e.g., classify data). Machine learning can include a training stage to train the model using ground truth data (e.g., data correctly labelled with a particular classification). Training a traditional neural network adjusts layers of weights of neurons of the neural network. After trained, data is input into the trained neural network and the layers of weights of the neurons are applied to input data to be able to process the input data to perform a function (e.g., classify data).

In some examples, an artificial intelligence based model is trained at a first location that is rich in resources (e.g., a server, a data center, one or more computers, etc.). Once trained, the device(s) that trained the model deploys information corresponding to the weights to a second device. In this manner, the second device can implement the model by utilizing the weights in a local model. As artificial intelligence-based models (e.g., neural networks, learning models, deep learning models, etc.) become more sophisticated (e.g., as models include an increasing number of layers and/or weights to generate more accurate classifications), the amount of memory, processing power, and bandwidth needed at the second device to obtain and/or store the generated weights increases. In some examples, if weights of a model are determined during training at a server and deployed to an IoT device. The IoT device needs to have sufficient memory bandwidth, memory, and/or processing resources to obtain and store the deployed weight information. In such examples, the IoT device may have limited memory bandwidth, memory, and/or processing resources.

To reduce the memory bandwidth, memory, and/or processing resources needed to obtain and implement the trained weight information locally, examples disclosed herein compress trained weight information to reduce the size of the trained weight information. Examples disclosed herein compress weight information by identifying temporal redundancy between channels. As used herein, a channel is a group of weights (e.g., convolutional kernels) in a particular layer of a model. Examples disclosed herein can compare channels within the same layer or across different layers of the model. Examples disclosed herein include encoding and/or compressing data based on differences between channels that are sufficiently similar (e.g., based on a similarity threshold). Because the amount of data needed to express a first channel relative to a second channel is smaller than the amount of data needed to express all the weights of the first channel, expressing channels based on differences relative to other channel values reduces the size of the deployed data. In this manner, the amount of memory bandwidth, memory, and/or processing resources needed to obtain and implement deployed weight data is reduced. Additionally, examples disclosed herein can be implemented to support lossless weight deployment as well as lossy weight deployment.

In general, implementing a ML/AI system involves two phases, a learning/training phase and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters may be used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. As used herein, labelling refers to an expected output of the machine learning model (e.g., a classification, an expected output value, etc.). Alternatively, unsupervised training (e.g., used in deep learning, a subset of machine learning, etc.) involves inferring patterns from inputs to select parameters for the ML/AI model (e.g., without the benefit of expected (e.g., labeled) outputs).

In examples disclosed herein, training is performed until a threshold number of actions have been predicted. In examples disclosed herein, training is performed either locally (e.g. in the device) or remotely (e.g., in the cloud and/or at a server). Training may be performed using hyperparameters that control how the learning is performed (e.g., a learning rate, a number of layers to be used in the machine learning model, etc.). In some examples re-training may be performed. Such re-training may be performed in response to a new program being implemented or a new user using the device. Training is performed using training data. When supervised training may be used, the training data is labeled. In some examples, the training data is pre-processed.

Once training is complete, the model is deployed for use as an executable construct that processes an input and provides an output based on the network of nodes and connections defined in the model. The model is stored locally in memory (e.g., stored in cache and moved into memory after trained) or may be stored in the cloud. The model may then be executed by the computer cores.

Once trained, the deployed model may be operated in an inference phase to process data. In the inference phase, data to be analyzed (e.g., live data) is input to the model, and the model executes to create an output. This inference phase can be thought of as the AI “thinking” to generate the output based on what it learned from the training (e.g., by executing the model to apply the learned patterns and/or associations to the live data). In some examples, input data undergoes pre-processing before being used as an input to the machine learning model. Moreover, in some examples, the output data may undergo post-processing after it is generated by the AI model to transform the output into a useful result (e.g., a display of data, an instruction to be executed by a machine, etc.).

In some examples, output of the deployed model may be captured and provided as feedback. By analyzing the feedback, an accuracy of the deployed model can be determined. If the feedback indicates that the accuracy of the deployed model is less than a threshold or other criterion, training of an updated model can be triggered using the feedback and an updated training data set, hyperparameters, etc., to generate an updated, deployed model.

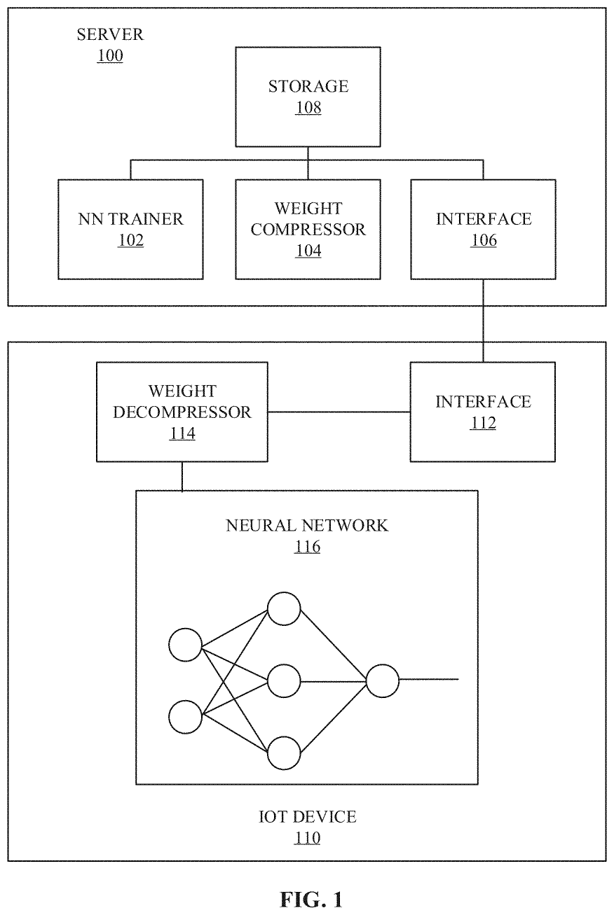

FIG. 1 is a schematic illustration of an example server 100 to deploy compressed weight information to implement an AI-based model. The example server 100 includes an example neural network (NN) trainer 102, an example weight compressor 104, an example storage 108, and an example interface 106. FIG. 1 further includes an IoT device 110 obtains compressed weight data corresponding to a trained AI-based model. The example IoT device 110 includes an example interface 112, an example weight decompressor 114, and an example neural network 116. Although the example of FIG. 1 is described in conjunction with a trained neural network, examples disclosed herein may be utilized in any AI-based system or model that includes weights. Additionally, although FIG. 1 includes the example server 100 to compress weight data and the example IoT device 110 to decompress the weight data, the server 100 could be a data center and/or any other computing device this, and the IoT device 110 may be any type of computing device that implements an AI-based model.

The example NN trainer 102 of FIG. 1 trains a model to be able to perform a task based on input data (e.g., identify objects in an image) by adjusting weights in layers of the model. Initially, before a model is trained, the neurons/weights of the model are not yet weighted. To train the model, the example NN trainer 102 of FIG. 1 uses training data (e.g., input data labelled with known classifications and/or outputs) to configure the model to be able to predict output classifications for input data with unknown classification. The example NN trainer 102 may train a model with a first set of training data and test the model with a second set of the training data. If, based on the results of the testing, the accuracy of the model is below a threshold, the example NN trainer 102 can tune (e.g., adjust, further train, etc.) the parameters of the model using additional sets of the training data and continue testing until the accuracy is above the threshold. After the NN trainer 102 has trained the model, the example NN trainer 102 provides the trained weights to the example weight compressor 104.

The example weight compressor 104 of FIG. 1 obtains and compresses the weight data generated by the NN trainer 102. The example NN trainer 102 generates a number of weights for each layer of a model. The weights of a layer are broken up into channels (e.g., groups of weights for a given layer). In some examples, a channel can be an array or matrix (e.g., with two or more dimensions) of weights. The example weight compressor 104 compresses the weight data by comparing channels to each other (e.g., in the same layer and/or in different layers) to look for channels that are sufficiently similar (e.g., when the comparison of two channels satisfies a similarity threshold).

To increase the number of channels that are sufficiently similar, the example weight compressor 104 of FIG. 1 may manipulate a channel to generate a plurality of manipulated channels. The manipulation may include changing the order of the weights in the channel by shifting the values, rotating values about some axis, flipping the values, inversing the values, etc. The example weight compressor 104 also compares the manipulated channels to other channels to find two channels (e.g., a pair of channels) that are sufficiently similar. For example, for a given channel, the weight compressor 104 performs a plurality of manipulations to the channel to generate a plurality of manipulated channels corresponding to the given channel. The example weight compressor 105 then compares the channel and the corresponding manipulated channels to other channels within the same layer or from other layers to determine similarity metrics for the plurality of comparisons. The example weight compressor 105 selects the pair of the channel or manipulated channel with another channel that results in the highest similarity. If the similarity satisfies a similarity threshold, the example weight compressor 105 generates a data packet that is based on the difference between the selected pair of channels. In this manner, the example weight decompressor 114 can determine the weight value by decoding the data packet. Because the compressed data packet requires less data than a full data packet including all weights of a channel, the compressed data packet requires less bandwidth and/or resources of the IoT device 110 to obtain and/or implement. After generating the compressed data packets, the example weight compressor 104 can store the compressed weighted data in the storage 108 and/or may transmit the compressed weighted data to the IoT device 110 using the example interface 106 (e.g., via a wired or wireless network connection and/or communication). The example weight compressor 104 is further described below in conjunction with FIG. 1.

The example IoT device 110 of FIG. 1 is a device that obtains trained model data and implements in the example neural network 116. The example IoT device 110 may be a smart device, a sensor, an edge device, an edge server, a fog device, a fog server, etc. Additionally or alternatively, the IoT device may be an end user device (e.g., a computer, a tablet, a mobile phone) and/or any other computing device.

The example interface 112 of the IoT device 110 of FIG. 1 obtains the compressed data packets corresponding to the weights to apply to the example neural network 115 to implement the trained model. In some examples, the interface 112 may store the obtained data in main memory (e.g., dynamic random-access memory (DRAM)). In such examples, the weight decompressor 114 accesses the compressed data from the main memory to decompress the data prior to implementing in the neural network 116 (e.g., by storing in local memory such as static random-access memory (SRAM)). In such examples, because the compressed data is stored in the main memory, the main memory can be smaller or store more data than traditional weight data.

The example weight decompressor 114 of FIG. 1 decompresses the obtained data packets. As described above, the weight decompressor 114 may obtain the data packets directly from the interface 112 and/or may obtain the data packets from a main memory that stores the data packets when received at the example interface 112 from the server 100. The example weight decompressor 114 processes the received data packets to determine whether individual data packets that correspond to trained channels correspond to a regular channel or a compressed channel (e.g., based on the data or metadata of the individual data packet). If a data packet corresponds to a regular channel, the weight decompressor 114 performs a normal processing technique to determine the weights of the channel based on the data packet and implements those weights in corresponding neurons, channels, and/or layers of the example neural network 116. Additionally, the example weight decompressor 114 may store the weight information for the channel in local memory. In this manner, the example weight decompressor 114 can use the stored weight information of the channel if a subsequent compressed data packet references the channel.

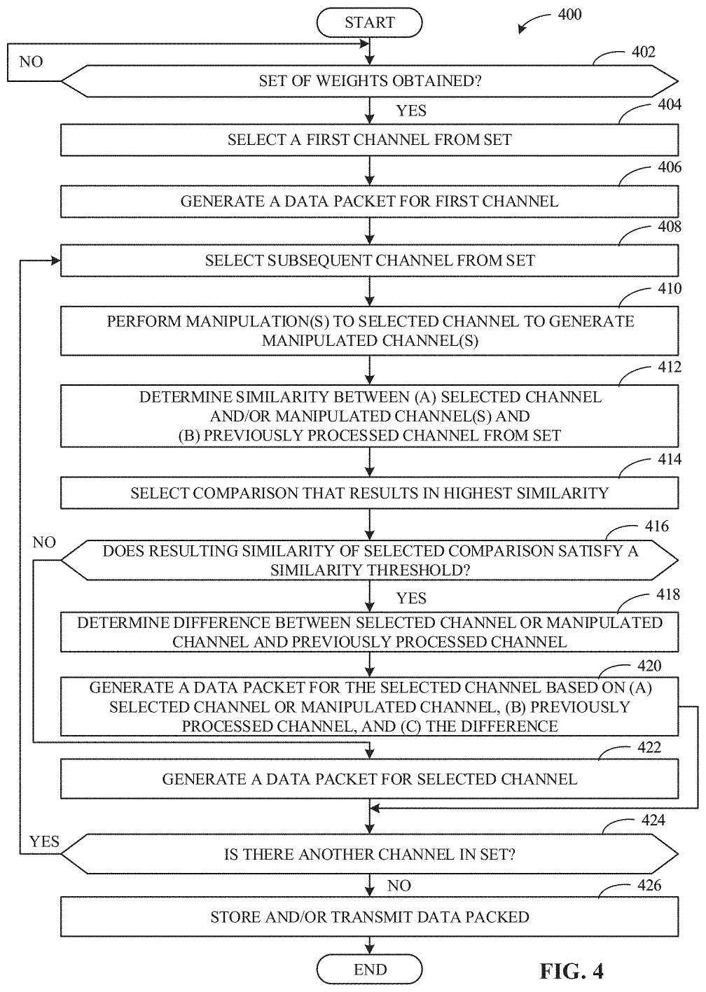

If the data packet corresponds to a compressed channel, the example weight decompressor 114 of FIG. 1 identifies the reference channel and/or any manipulation information (e.g., how to rotate, move, flip, etc., the reference channel) from the metadata of the data packet. The example weight decompressor 114 obtains the reference channel from the local storage. After the reference channel is obtained, the example weight decompressor 114 determines the difference value from the residual data payload of the data packet. The difference value identifies how the reference channel or manipulated reference channel is different than the channel corresponding to the currently processed data packet. Accordingly, the example weight decompressor 114 adjusts the reference channel or manipulated reference channel by the difference value to obtain the channel weight information for the data packet. After adjusting, the example weight decompressor 114 performs a manipulation to the adjusted weights of the reference channel according to the manipulation information (e.g., if the metadata correspond to a manipulation), as further described below. The example weight decompressor 114 implements those determined weight information in corresponding neurons, channels, and/or layers of the example neural network 116. Additionally, the example weight decompressor 114 may store the weight information for the channel in local memory. In this manner, the example weight decompressor 114 can use the stored weight information of the channel if a subsequent compressed data packet references the channel. The example weight decompressor 114 is further described below in conjunction with FIG. 3.

The example neural network 116 of FIG. 1 implements a trained model based on the weight information sent from the example server 100. Initially the example neural network 116 is unweighted. However, after the weights from the example weight decompressor 114 are applied to the weights and/or neurons of the neural network 116, the example neural network 116 can perform a task based on input data. For example, if the server 100 transmitted data to classify animals in images, after the neural network 116 is trained with the corresponding weight information, the neural network 16 can classify animals based on input images. Although the example IoT device 110 implements the example neural network 116, the IoT device 110 may additionally or alternatively implement any other type of AI-based model that includes weights.

In some examples, the example server 100 is rich with resources (e.g., processing resources, power, memory etc.), while the example IoT device 110 may have limited resources. Accordingly, the example server 110 is able to perform the heavy and/or complex computations associated with training models and compressing model data on the compression side. In this manner, the less complex decompression techniques can be performed at the example IoT device 110, thereby conserving resources of the IoT device 110, where the resources may be constrained. The additional overhead corresponding to the compressed model data is limited to ensure that the additional overhead will not affect the overall compression performance.

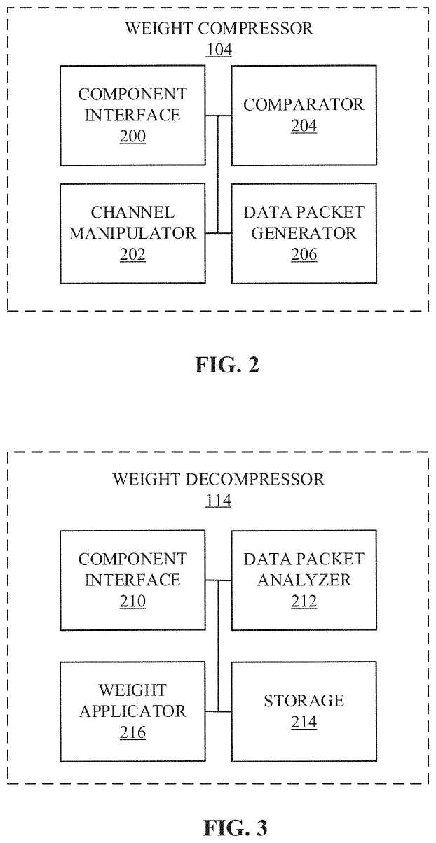

FIG. 2 is a block diagram of the example weight compressor 104 of FIG. 1. The example weight compressor 104 of FIG. 2 includes an example component interface 200, an example channel manipulator 202, an example comparator 204, and an example data packet generator 206.

The example component interface 200 of FIG. 2 obtains the weight information corresponding to a trained model from the example NN trainer 102 of FIG. 1. As described above, the weight information includes weights grouped into channel for any number of layers of the model. The example component interface 200 also transmits data packets corresponding to the weighted information (e.g., the compressed weighted data) to the example interface 106 of FIG. 1 (e.g., to be deployed to the example IoT device 110 (FIG. 1)) and/or the example storage 108 of FIG. 1 (e.g., to be stored locally).

When the channels that include the weighted information are obtained, the example channel manipulator 202 of FIG. 2 selects a particular channel (e.g., an analyzed channel, an in-process channel, etc.) and performs a plurality of pre-defined manipulations to the channel to generate a plurality of manipulated channels. As described above, channel information may be a matrix including weights. The example channel manipulator 202 can shift the data in the channel (e.g., shift the entries of the matrix), rotate the data in the channel (e.g., perform a rotation of the data in the matrix), flip the data in the channel (e.g., flip the data across an x axis, y axis, and/or diagonal axis of the matrix), invert the data in the channel (e.g., if the data includes zeros and ones, invert the zeros to ones and the ones to zeros), and/or a combination of any type of manipulation.

The example comparator 204 of FIG. 2, for an analyzed channel, compares the channel to the reference channels (e.g., previously processed channels for the model) to determine amounts of similarity between the channel and the reference channels. For example, the comparator 205 may perform a sum of the absolute difference operation between the channel and each reference channel. Additionally or alternatively, the example comparator 205 can perform any type of similarity measure between two sets of values. Additionally, the example comparator 204 compares the manipulated channels to each of the reference channels. In this manner, for an analyzed channel, the comparator 204 compares a similarity between itself and/or manipulated version(s) of itself to other previously processed channels (e.g., reference channels) to generate a plurality of similarity comparisons. After the similarity comparisons, the example comparator 204 identifies the similarity comparison that results in the highest similarity (e.g., the lowest absolute difference). The example comparator 204 compares the identified highest similarity to a similarity threshold. In some examples, instead of selecting the highest similarity, the comparator 204 may compare all the determined similarities to the similarity threshold and select one of the comparisons that results in a similarity that satisfies the threshold. If the example comparator 204 determines that the identified highest similarity satisfies the similarity threshold, the comparator 204 determines the difference between the corresponding channels of the comparison (e.g., a difference between the reference channel and the analyzed channel or manipulated channel corresponding to the comparison). Additionally, the example comparator 204 outputs the corresponding channels of the comparison and the determined difference to the data packet generator 206. If the example comparator 204 determines that the identified highest similarity does not satisfy the similarity threshold, the comparator 204 outputs an indication that the similarity threshold has not been satisfied for the channel to the example data packet generator 206.

The example data packet generator 206 of FIG. 2 generates data packets for the channels corresponding to the trained model. For an analyzed channel, if the example data packet generator 206 obtains an indication that the comparisons for the channel did not result in satisfying the similarity threshold, the data packet generator 206 generates a data packet identifying the weights for the channel. If the example data packet generator 206 obtains corresponding channels of a comparison and a difference value from the comparator 204, the data packet generator 206 generates a compressed data packet that includes the manipulation data (if any), a value indicative of the reference channel, and the difference between the analyzed channel/manipulated channel and the reference channel. The compressed data packet includes less data than the regular data packet (e.g., uncompressed) and can be decoded at the IoT device 110 to determine and implement the weights for the analyzed channel.

FIG. 3 is a block diagram of the example weight decompressor 114 of FIG. 1. The example weight decompressor 114 of FIG. 3 includes an example component interface 210, an example data packet analyzer 212, example storage 214, and an example weight applicator 216.

The example component interface 210 of FIG. 2 obtains the data packets from the example interface 112 (FIG. 1) and/or from main memory (e.g., if the interface 112 stores received data packets in main memory). Additionally, the example component interface 210 interfaces with the neural network 116 (FIG. 1) to apply weight values to the neurons and/or layers of the neural network 116 after the obtained data packets have been decoded and/or decompressed.

The example data packet analyzer 212 of FIG. 2 processes obtained data packets to extract information corresponding to a channel. For example, the data packet analyzer 212 may process metadata of a data packet to determine if the information in the data packet identifies weights in a channel or a comparison to a reference channel (e.g., that needs to be decoded and/or decompressed to obtain the weights for the channel). If the example data packet analyzer 212 determines that the data packet includes the weight information of a channel (e.g., that does not need to be decompressed), the data packet analyzer 212 stores the weight information for the channel in the storage 214 and transmits the weight information to the weight applicator 216. If the example data packet analyzer 212 determines that the data packet includes a comparison to a reference channel (e.g., that needs to be decompressed), the data packet analyzer 212 extracts the manipulation information, the reference channel information, and/or the difference value from the data packet. The manipulation information may be a value indicative of how the channel was manipulated at the example weight compressor 104, the reference channel information may be a value indicative of the channel used in the comparison at the weight compressor 104, and the difference value is a value indicative of a difference between the channel/manipulated channel and the reference channel. The example data packet analyzer 212 provides the extracted information to the example weight applicator 216.

The example storage 214 of FIG. 2 stores the weight information for channels of processed data packets. In this manner, the previous weight information for channels can be used as reference channels for subsequent decompressions for subsequently processed channels. The example storage 214 may be a local memory, such as SRAM and/or any type of storage.

The example weight applicator 216 of FIG. 2 obtains the weight information and/or the extracted information corresponding to a channel from the data packet analyzer 212. If the weight applicator 216 obtains the weight information, the weight applicator 216 implements the weights at the corresponding channel of the example neural network 116 (e.g., via the component interface 210). If the example weight applicator 216 obtains the extracted information corresponding to a channel, the weight applicator 216 accesses the reference channel identified in the extracted information from the example storage 214. After the reference channel is obtained, the example weight applicator 216 adjusts the reference channel based on the difference value. As described above, the difference value corresponds to the difference between the reference value and the analyzed channel (if not manipulated) or manipulated channel (if the analyzed channel was manipulated). Thus, adjusting the reference channel by the difference value results in the channel information corresponding to the analyzed channel or manipulated channel. If the analyzed channel was not manipulated (e.g., the extracted data corresponded to no manipulation), the example weight applicator 216 implements the adjusted weight values at the corresponding channel of the example neural network 116 (e.g., via the component interface 210). If the analyzed channel was manipulated (e.g., the extracted data corresponded to a manipulation), the example weight applicator 216 performs a reverse manipulation of the adjusted weight values for the channel. For example, if the extracted data from the data packet identifies a shift of the weights in the channel by three positions in a first direction, the weight applicator 216 shifts the adjusted weights for the channels by three positions in a second direction opposite the first direction. The result corresponds to the weights of the analyzed channel. After the manipulation, the example weight applicator 216 implements the adjusted and manipulated weight values at the corresponding channel of the example neural network 116 (e.g., via the component interface 210).

While an example manner of implementing the weight compressor 104 of FIG. 1 is illustrated in FIG. 2 and an example manner of implementing the weight decompressor 114 of FIG. 1 is illustrated in FIG. 3, one or more of the elements, processes and/or devices illustrated in FIGS. 1-3 may be combined, divided, re-arranged, omitted, eliminated and/or implemented in any other way. Further, the example component interface 200, the example channel manipulator 202, the example comparator 204, the example data packet generator 206, and/or, more generally, the example weight compressor 104 of FIG. 2, and the example component interface 210, the example data packet analyzer 212, the example weight applicator 216, the example storage 214, and/or, more generally, the example weight decompressor 114 of FIG. 3 may be implemented by hardware, software, firmware and/or any combination of hardware, software and/or firmware. Thus, for example, any of the example component interface 200, the example channel manipulator 202, the example comparator 204, the example data packet generator 206, and/or, more generally, the example weight compressor 104 of FIG. 2, and the example component interface 210, the example data packet analyzer 212, the example weight applicator 216, the example storage 214, and/or, more generally, the example weight decompressor 114 of FIG. 3 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one the example component interface 200, the example channel manipulator 202, the example comparator 204, the example data packet generator 206, and/or, more generally, the example weight compressor 104 of FIG. 2, and the example component interface 210, the example data packet analyzer 212, the example weight applicator 216, the example storage 214, and/or, more generally, the example weight decompressor 114 of FIG. 3 is/are hereby expressly defined to include a non-transitory computer readable storage device or storage disk such as a memory, a digital versatile disk (DVD), a compact disk (CD), a Blu-ray disk, etc. including the software and/or firmware. Further still, the example weight compressor 112 and/or weight decompressor 114 of FIGS. 1-3 may include one or more elements, processes and/or devices in addition to, or instead of, those illustrated in FIGS. 1-3, and/or may include more than one of any or all of the illustrated elements, processes, and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

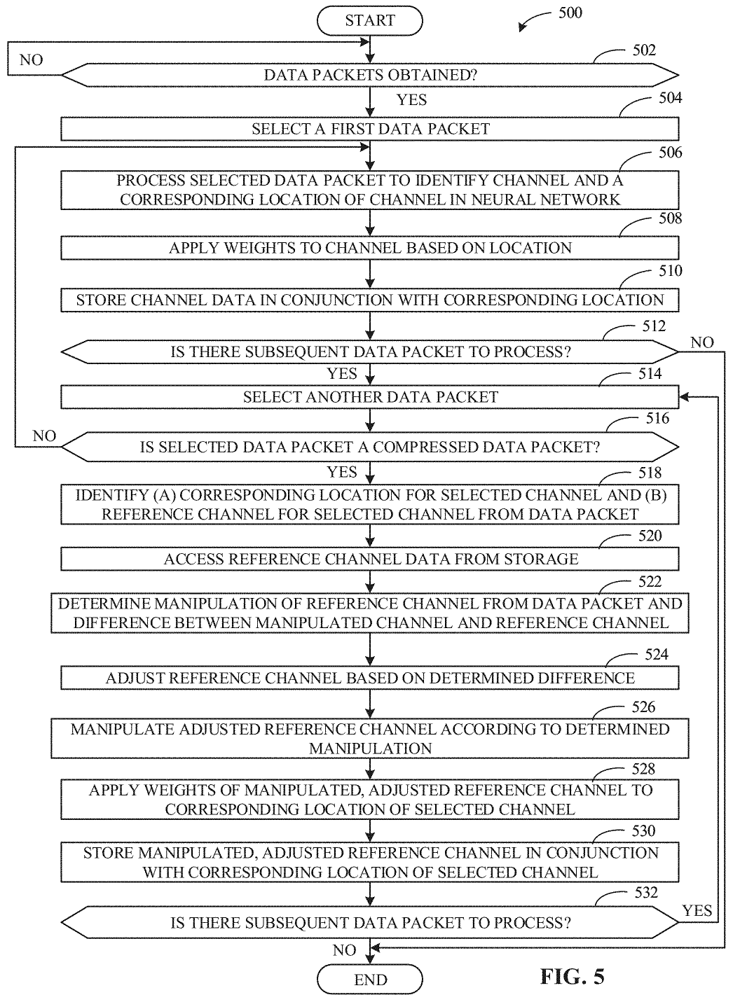

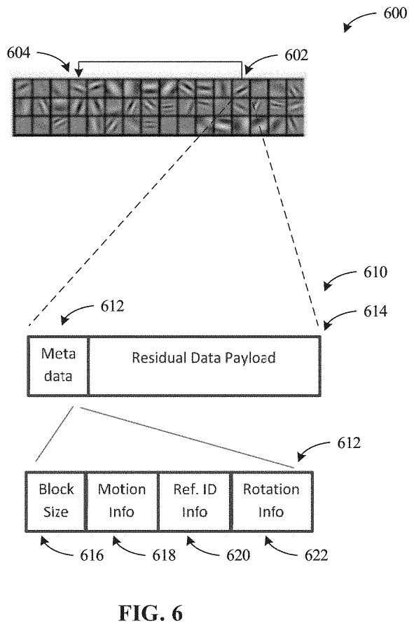

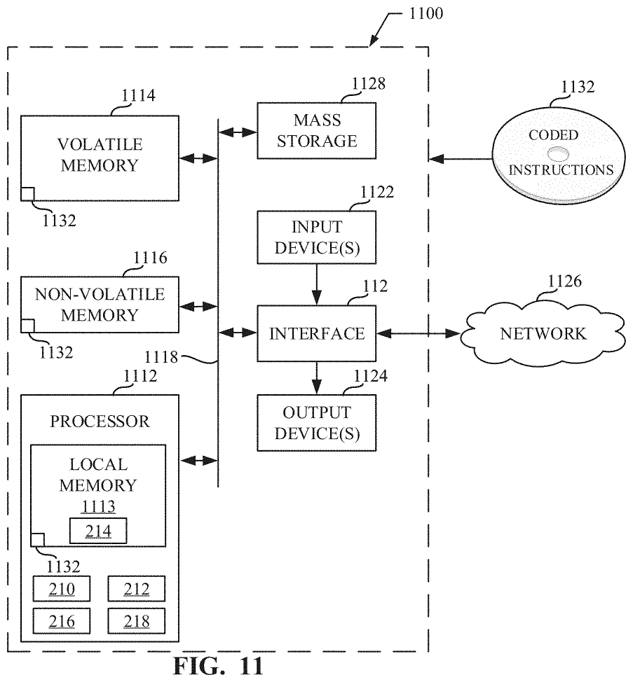

Flowcharts representative of example hardware logic, machine readable instructions, hardware implemented state machines, and/or any combination thereof for implementing the example weight compressor 104 and/or the example weight decompressor 114 of FIGS. 1-3 are shown in FIGS. 4 and 5. The machine readable instructions may be one or more executable programs or portion(s) of an executable program for execution by a computer processor such as the processor 1012, 1112 shown in the example processor platform 1000 discussed below in connection with FIGS. 10 and/or 11. The program(s) may be embodied in software stored on a non-transitory computer readable storage medium such as a CD-ROM a floppy disk, a hard drive, a DVD, a Blu-ray disk, or a memory associated with the processor 1012, 1112 but the entire program(s) and/or parts thereof could alternatively be executed by a device other than the processor 1012, 1112 and/or embodied in firmware or dedicated hardware. Further, although the example program(s) is/are described with reference to the flowcharts illustrated in FIGS. 4 and/or 5, many other methods of implementing the example weight compressor 104 and/or the example weight decompressor 114 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

The machine readable instructions described herein may be stored in one or more of a compressed format, an encrypted format, a fragmented format, a compiled format, an executable format, a packaged format, etc. Machine readable instructions as described herein may be stored as data (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers). The machine readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement a program such as that described herein.

In another example, the machine readable instructions may be stored in a state in which they may be read by a computer, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, the disclosed machine readable instructions and/or corresponding program(s) are intended to encompass such machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example processes of FIGS. 4-5 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

FIG. 4 is a flowchart representative of example machine readable instructions 400 which may be executed to implement the weight compressor 104 of FIGS. 1 and/or 2 to compress weight data corresponding to a trained AI-based model. Although the instructions 400 are described in conjunction with the example server 100 of FIG. 1, the instructions 400 may be described in conjunction with any device that generates weights for a model.

At block 402, the example component interface 200 (FIG. 2) determines if a set of weights or channels of weights has been obtained from the NN trainer 102 (FIG. 1) or the storage 108 (FIG. 1). The example NN trainer 102 may output the weights to the example weight compressor 104 and/or the storage 108 after training an AI-based model. If the example component interface 200 determines that a set of weights or channels of weight has/have not been obtained (block 402: NO), control returns to block 402 until a set of weights and/or channels of weights have been obtained. If the example component interface 200 determines that a set of weights or channels of weights has/have been obtained (block 402: YES), the example data packet generator 206 (FIG. 2) selects a first channel from the set of weights (block 404).

At block 406, the example data packet generator 206 generates a data packet for the first channel. The data packet identifies weight values for all the weights of the channel. When the first channel is processed, there are no reference channels available because there are no previously processed channels to which the first selected channel can be compared. Accordingly, the data packet generator 206 generates the data packet without attempting to compress the weight information for the channel. However, for every subsequent channel, the weight compressor 104 will compare the subsequent channel to reference channels (e.g., previously processed channels) to attempt to compress the channel based on the comparison, as further described below.

At block 408, the example channel manipulator 202 of FIG. 2 selects a subsequent channel from the obtained set. The order of selection of the channels may be subsequently (e.g., in channel order and/or layer order), or in any other order. The order of selection should be known to the weight decompressor 114 (FIG. 1) so that it can select channels in the same or a similar order. At block 410, the example channel manipulator 202 performs one or more manipulations to the selected channel to generate manipulated channels. The manipulations may be entry shifts (e.g., by 1 entry, 2 entries, three entries, etc. in any direction), rotation of entries, inverting weights of the channel (e.g., if a weights, w, is a value between 0 and 1, inverting the weight based on 1−w), flip entries over one or more axes, and/or a combination of different manipulations.

At block 412, the example comparator 204 determines similarities based on comparisons between (a) the selected channel and/or manipulated channel(s) and (b) previously processed channels from the set (e.g., reference channels). For example, if the channel manipulator 202 performed nine different manipulations to the selected channel, the comparator 204 determines ten similarities for each of the previously processed channels (e.g., for the selected channel and the first previous channel, the first manipulated channel and the first previous channel, the second manipulated channel and the first previous channel, . . . , and the ninth manipulated channel and last previous channel). As described above, the example comparator 204 may perform the comparison using a sum of the absolute difference operation, or any other statistical similarity determination protocol.

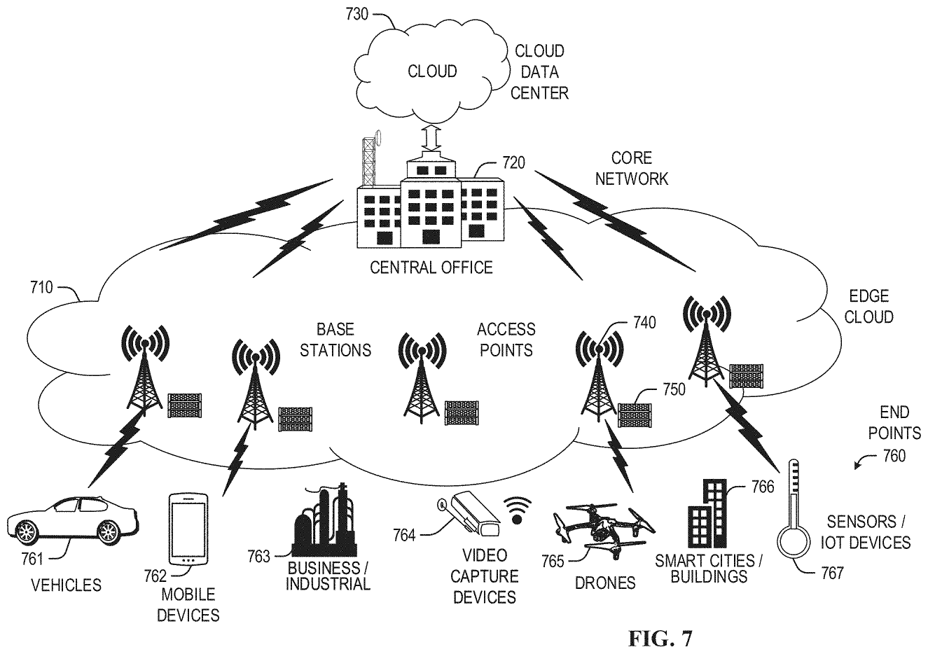

At block 414, the example comparator 204 selects the comparison that results in the highest similarity (e.g., the lowest sum of the absolute difference operation). At block 416, the example comparator 204 determines if the resulting similarity for the selected comparison (e.g. the highest similarity) satisfies a similarity threshold (e.g., the determined similarity is sufficient). If the example comparator 204 determines that the resulting similarity of the selected comparison does not satisfy the similarity threshold (bock 416: NO), control continues to block 422. If the example comparator 204 determines that the resulting similarity of the selected comparison satisfies the similarity threshold (block 416: YES), the example comparator 204 determines a difference between (a) the selected channel or manipulated channel from the selected comparison and (b) the previous processed channel from the selected comparison (block 418). At block 420, the example data packet generator 206 generates a data packet for the selected channel based on (a) the selected channel or manipulated channel that corresponds to the selected comparison, (b) the previously processed channel that corresponds to the selected comparison, and (c) the corresponding difference. An example of a data packet that includes the corresponding information is further described below in conjunction with FIG. 6.

If the example comparator 204 determines that the resulting similarity of the selected comparison does not satisfy the similarity threshold (bock 416: NO), the example data packet generator 206 generates a data packet including the weight information for the selected channel (e.g., without compressing the data based on a comparison to a reference channel) (block 422). At block 424, the example channel manipulator 202 determines if there is another channel in the set to process. If there is another in the set to process (block 424: YES), control returns to block 408 process the subsequent channel to generate a corresponding data packet. If there is not another channel in the set to process (block 424: NO), the component interface 200 stores the generated data packet in the example storage 108 (FIG. 1) and/or provides the generated data packet to the example interface 106 (FIG. 1) to be transmitted to the example IoT device 110 (FIG. 1) (block 426). The example instructions of FIG. 4 end.

FIG. 5 is a flowchart representative of example machine readable instructions 500 which may be executed to implement the weight decompressor 114 of FIGS. 1 and/or 3 to decompress and/or decode data packets to implement a trained AI-based model at the IoT device 110. Although the instructions 500 are described in conjunction with the example IoT device 110 of FIGS. 1 and/or 3, the instructions 500 may be described in conjunction with any device that implements an AI-based model.

At block 502, the example component interface 210 (FIG. 2) determines if data packets corresponding to a trained model have been obtained (e.g., from the example interface 112 (FIG. 1) and/or memory of the IoT device 110 (FIG. 1)). If the example component interface 210 determines that data packets have not been obtained (block 502: NO), control returns to block 502 until data packets are obtained. If the example component interface 210 determines that data packets have been obtained (block 502: YES), the example data packet analyzer 212 (FIG. 2) selects a first data packet from the set of data packets corresponding to the trained model (block 504). Each data packet may correspond to a channel of a layer in the trained model.

At block 506, the example data packet analyzer 212 processes the selected data packet to identify the channel and a corresponding location (e.g., location of the node, layer, etc.) in the neural network 116 (FIG. 1) to implement the weights of the channel identified in the selected data packet. At block 508, the example weight applicator 216 (FIG. 2) applies the weights of the data packet to the channel in the neural network 116 (e.g., via the component interface 210) based on the location of the node in the neural network 116. At block 510, the example weight applicator 216 stores the channel data (e.g., the identified channel and corresponding weights) in conjunction with the corresponding location in the example storage 214 (FIG. 2). In this manner, the weight decompressor 114 can use the channel data as a reference for subsequent data packet decompressions.

At block 512, the example data packet analyzer 212 determines if there is another data packets to process. If the example data packet analyzer 212 determines that there are no more data packets to process (block 512: NO), the control ends. If the example data packet analyzer 212 determines that there is another data packet to process (block 512: YES), the example data packet analyzer 212 selects a subsequent data packet (block 514). At block 516, the example data packet analyzer 212 determines if the selected data packet is a compressed data packet or a non-compressed data packet. The example data packet analyzer 212 may determine that the selected data packet is compressed based on a value of the data packet that identifies compression and/or decompression, the structure of the data packet, and/or the size of the data packet. If the example data packet analyzer 212 determines that the selected data packet is not a compressed data packet (block 516: NO), control returns to block 506.

If the example data packet analyzer 212 determines that the selected data packet is a compressed data packet (block 516: YES), the example data packet analyzer 212 analyzes the data packed to identify (A) the corresponding location of a node within a layer of the neural network 116 for the selected channel and (b) the reference channel for the selected channel from the data packet (block 518). For example, the location of the selected channel and an identification of the reference channel may be included in metadata of the data packet. The identification of the reference channel may be an identifier or a value corresponding to the location of the channel with respect to the selected channel (e.g., 4 channels away from the selected channel).

At block 520, the example weight applicator 216 accesses the channel data corresponding to the identified reference channel from the example storage 214. At block 522, the example data packet analyzer 212 determines the manipulation type (e.g., shift, invert, rotate, etc.) and/or amount from the data packet and the difference between the manipulated channel and/or the reference channel. At block 524, the example data packet analyzer 212 adjusts the reference channel weights based on the determined difference. As described above, the difference value identifies a difference between the weights of the reference channel and the weights of the currently processed channel (after manipulation, if manipulated during compression). Accordingly, the difference value is used to remove the difference between the weights of the reference channel and the processed channel and/or manipulated channel.

At block 526, the example weight applicator 216 manipulates the adjusted reference channel according to the determined manipulation. For example, if the manipulation is a clockwise rotation of the weights of the channel by 180 degrees, the weight applicator 216 rotates the adjusted weights 180 degrees counter clockwise to get the proper weights of the channel prior to compression. If no manipulation is identified, block 526 is skipped and the weights for the channel correspond to the weights of the adjusted reference channel. At block 528, the example weight applicator 216 applies the weights of the manipulated, adjusted reference channel to the corresponding location of the selected channel in the example neural network 116 using the example component interface 210.

At block 530, the example weight applicator 216 stores the weights of the manipulated, adjusted reference channel in conjunction with the corresponding location of the selected channel. In this manner, the weights of the selected channel can be used as a reference channel for subsequent data packets, if needed. At block 532, the example data packet analyzer 212 determines if there is another data packet for another channel to process. If the example data packet analyzer 212 determines that there is another data packet for another channel to process (block 532: YES), control returns to block 514 to process the subsequent data packet. If the example data packet analyzer 212 determines that there is not another data packet for another channel to process (block 532: NO), control ends.

FIG. 6 illustrates example channels 600 for a layer corresponding to a trained model and an example compressed data packet 610. The example channels 600 include an example analyzed channel 602 and an example reference channel 604. The example compressed data packet 610 is representative of the example analyzed channel 602 and includes example metadata 612 and an example residual data payload 614. The example metadata 612 includes an example block size field 66, an example motion information field 618, an example reference identifier (ID) information field 620, and an example rotation information field 622.

The example channels 600 of FIG. 2 include 48 channels of weights (e.g., convolutional kernels) of size 11×11×3 (e.g., the dimensions of the matrix of weights per channel) for a deep convolutional neural network (e.g., AlexNet). However, examples disclosed herein may be utilized in conjunction with any type number/size of channels and/or any dimensions for any layer of any type of AI-based model. Using examples disclosed herein, the example weight compressor 104 (FIG. 1), when processing/coding a data packet for the analyzed channel 602, determines that a comparison of the example reference channel 604 and a rotated version (e.g., a 180-degree rotation of the weights in the 11×11×3 channel around the z axis) of the analyzed channel 602 results in a similarity value that satisfies a similarity threshold. Accordingly, the example weight compressor 104 generates the example data packet 610 based on a difference between the reference channel 604 and the analyzed channel 602 after rotation.

The example data packet 610 of FIG. 6 includes example metadata 612 and the example residual data payload 614. The example metadata 612 includes data that can be used to identify the manipulation information corresponding to the comparison that satisfies the similarity threshold and data that can be used to identify the reference channel 604. The example residual data payload 614 may include the difference between the reference channel 604 and the analyzed channel 602 after rotation and/or an identifier of the location of the analyzed channel 602 and/or the layer.

The example metadata 612 of FIG. 6 includes a block size field 616 to identify the size of the data packet 610 (e.g., for variable length data packets). If the example data packet 610 is limited to a predefined size, the block size field 616 may be excluded from the metadata 612. The example motion information filed 618 includes values to reflect the type or amount of movement of the weights within the channel that correspond to the manipulation and the rotation information field 622 includes values to reflect the type or amount of rotation of the weights within the channel that correspond to the manipulation. Additionally or alternatively, the example metadata 612 may include additional fields to correspond to other types of manipulation (e.g., inverse, flip, etc.) and/or one field that can reflect multiple different types of manipulations. For the example analyzed channel 602, the motion info 618 includes a value indicative of no motion, and the rotational info 622 includes a value indicative of a 180-degree rotation about the z axis. The example reference ID information field 620 includes an identifier of the reference channel 604. In some examples, the identifier may be a value corresponding to how far away the reference channel 604 is away from the analyzed channel 602. For example, because the reference channel 604 is nine channels away from the analyzed channel 602, the reference ID information field 620 may include a value of nine to reflect the distance.

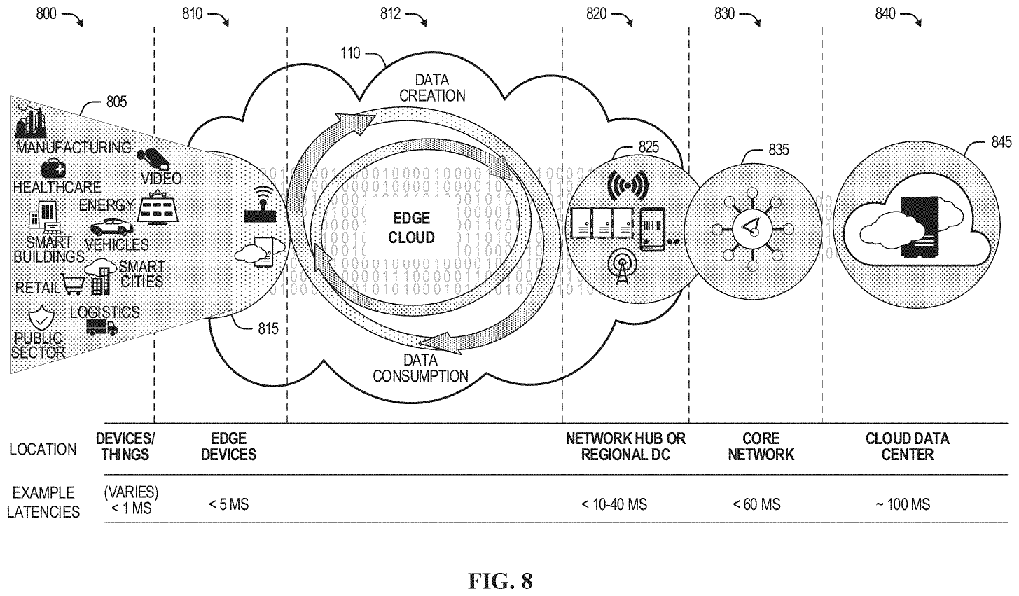

FIG. 7 is a block diagram 700 showing an overview of a configuration for edge computing, which includes a layer of processing referred to in many of the following examples as an “edge cloud”. As shown, the edge cloud 710 is co-located at an edge location, such as an access point or base station 740, a local processing hub 750, or a central office 720, and thus may include multiple entities, devices, and equipment instances. The edge cloud 710 is located much closer to the endpoint (consumer and producer) data sources 760 (e.g., autonomous vehicles 761, user equipment 762, business and industrial equipment 763, video capture devices 764, drones 765, smart cities and building devices 766, sensors and IoT devices 767, etc.) than the cloud data center 730. Compute, memory, and storage resources which are offered at the edges in the edge cloud 710 are critical to providing ultra-low latency response times for services and functions used by the endpoint data sources 760 as well as reduce network backhaul traffic from the edge cloud 710 toward cloud data center 730 thus improving energy consumption and overall network usages among other benefits. In some examples, one or more of the cloud data center 730, the central office 720, and/or one or more of the devices in the edge cloud 710 may implement the weight compressor 104 of FIG. 2 and one or more of the central office 720, one or more of the devices in the edge cloud 710, and/or the end points 760 may implement the weight decompressor 114 of FIG. 3.

Compute, memory, and storage are scarce resources, and generally decrease depending on the edge location (e.g., fewer processing resources being available at consumer endpoint devices, than at a base station, than at a central office). However, the closer that the edge location is to the endpoint (e.g., user equipment (UE)), the more that space and power is often constrained. Thus, edge computing attempts to reduce the amount of resources needed for network services, through the distribution of more resources which are located closer both geographically and in network access time. In this manner, edge computing attempts to bring the compute resources to the workload data where appropriate, or, bring the workload data to the compute resources.

The following describes aspects of an edge cloud architecture that covers multiple potential deployments and addresses restrictions that some network operators or service providers may have in their own infrastructures. These include, variation of configurations based on the edge location (because edges at a base station level, for instance, may have more constrained performance and capabilities in a multi-tenant scenario); configurations based on the type of compute, memory, storage, fabric, acceleration, or like resources available to edge locations, tiers of locations, or groups of locations; the service, security, and management and orchestration capabilities; and related objectives to achieve usability and performance of end services. These deployments may accomplish processing in network layers that may be considered as “near edge”, “close edge”, “local edge”, “middle edge”, or “far edge” layers, depending on latency, distance, and timing characteristics.

Edge computing is a developing paradigm where computing is performed at or closer to the “edge” of a network, typically through the use of a compute platform (e.g., x86 or ARM compute hardware architecture) implemented at base stations, gateways, network routers, or other devices which are much closer to endpoint devices producing and consuming the data. For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

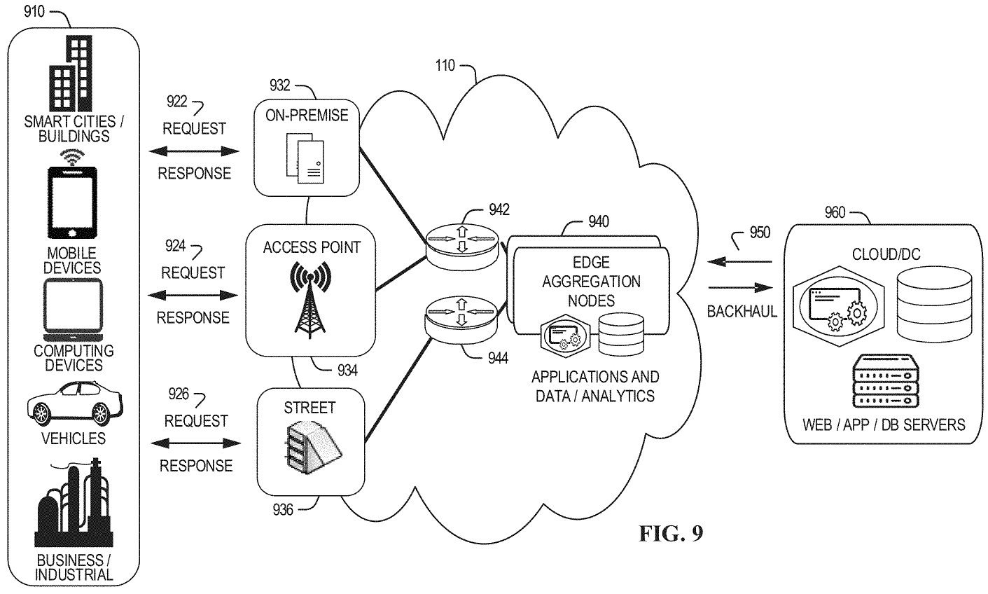

FIG. 8 illustrates operational layers among endpoints, an edge cloud, and cloud computing environments. Specifically, FIG. 8 depicts examples of computational use cases 805, utilizing the edge cloud 710 among multiple illustrative layers of network computing. The layers begin at an endpoint (devices and things) layer 800, which accesses the edge cloud 710 to conduct data creation, analysis, and data consumption activities. The edge cloud 710 may span multiple network layers, such as an edge devices layer 810 having gateways, on-premise servers, or network equipment (nodes 815) located in physically proximate edge systems; a network access layer 820, encompassing base stations, radio processing units, network hubs, regional data centers (DC), or local network equipment (equipment 825); and any equipment, devices, or nodes located therebetween (in layer 812, not illustrated in detail). The network communications within the edge cloud 710 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer 800, under 5 ms at the edge devices layer 810, to even between 10 to 40 ms when communicating with nodes at the network access layer 820. Beyond the edge cloud 710 are core network 830 and cloud data center 840 layers, each with increasing latency (e.g., between 50-60 ms at the core network layer 830, to 100 or more ms at the cloud data center layer). As a result, operations at a core network data center 835 or a cloud data center 845, with latencies of at least 50 to 100 ms or more, will not be able to accomplish many time-critical functions of the use cases 805. Each of these latency values are provided for purposes of illustration and contrast; it will be understood that the use of other access network mediums and technologies may further reduce the latencies. In some examples, respective portions of the network may be categorized as “close edge”, “local edge”, “near edge”, “middle edge”, or “far edge” layers, relative to a network source and destination. For instance, from the perspective of the core network data center 835 or a cloud data center 845, a central office or content data network may be considered as being located within a “near edge” layer (“near” to the cloud, having high latency values when communicating with the devices and endpoints of the use cases 805), whereas an access point, base station, on-premise server, or network gateway may be considered as located within a “far edge” layer (“far” from the cloud, having low latency values when communicating with the devices and endpoints of the use cases 805). It will be understood that other categorizations of a particular network layer as constituting a “close”, “local”, “near”, “middle”, or “far” edge may be based on latency, distance, number of network hops, or other measurable characteristics, as measured from a source in any of the network layers 800-840. In some examples, one or more of the cloud data center 845, the network data center 835, and/or the equipment 825 may implement the weight compressor 104 of FIG. 2 and one or more of the network data center 835, the equipment 825, and/or the devices and endpoints of the use cases 805 may implement the weight decompressor 114 of FIG. 3.

The various use cases 805 may access resources under usage pressure from incoming streams, due to multiple services utilizing the edge cloud. To achieve results with low latency, the services executed within the edge cloud 710 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to SLA, the system as a whole (components in the transaction) may provide the ability to (1) understand the impact of the SLA violation, and (2) augment other components in the system to resume overall transaction SLA, and (3) implement steps to remediate.

Thus, with these variations and service features in mind, edge computing within the edge cloud 710 may provide the ability to serve and respond to multiple applications of the use cases 805 (e.g., object tracking, video surveillance, connected cars, etc.) in real-time or near real-time, and meet ultra-low latency requirements for these multiple applications. These advantages enable a whole new class of applications (Virtual Network Functions (VNFs), Function as a Service (FaaS), Edge as a Service (EaaS), standard processes, etc.), which cannot leverage conventional cloud computing due to latency or other limitations.

However, with the advantages of edge computing comes the following caveats. The devices located at the edge are often resource constrained and therefore there is pressure on usage of edge resources. Typically, this is addressed through the pooling of memory and storage resources for use by multiple users (tenants) and devices. The edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required, because edge locations may be unmanned and may even need permissioned access (e.g., when housed in a third-party location). Such issues are magnified in the edge cloud 710 in a multi-tenant, multi-owner, or multi-access setting, where services and applications are requested by many users, especially as network usage dynamically fluctuates and the composition of the multiple stakeholders, use cases, and services changes.

At a more generic level, an edge computing system may be described to encompass any number of deployments at the previously discussed layers operating in the edge cloud 710 (network layers 800-840), which provide coordination from client and distributed computing devices. One or more edge gateway nodes, one or more edge aggregation nodes, and one or more core data centers may be distributed across layers of the network to provide an implementation of the edge computing system by or on behalf of a telecommunication service provider (“telco”, or “TSP”), internet-of-things service provider, cloud service provider (CSP), enterprise entity, or any other number of entities. Various implementations and configurations of the edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 710.

As such, the edge cloud 710 is formed from network components and functional features operated by and within edge gateway nodes, edge aggregation nodes, or other edge compute nodes among network layers 810-830. The edge cloud 710 thus may be embodied as any type of network that provides edge computing and/or storage resources which are proximately located to radio access network (RAN) capable endpoint devices (e.g., mobile computing devices, IoT devices, smart devices, etc.), which are discussed herein. In other words, the edge cloud 710 may be envisioned as an “edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

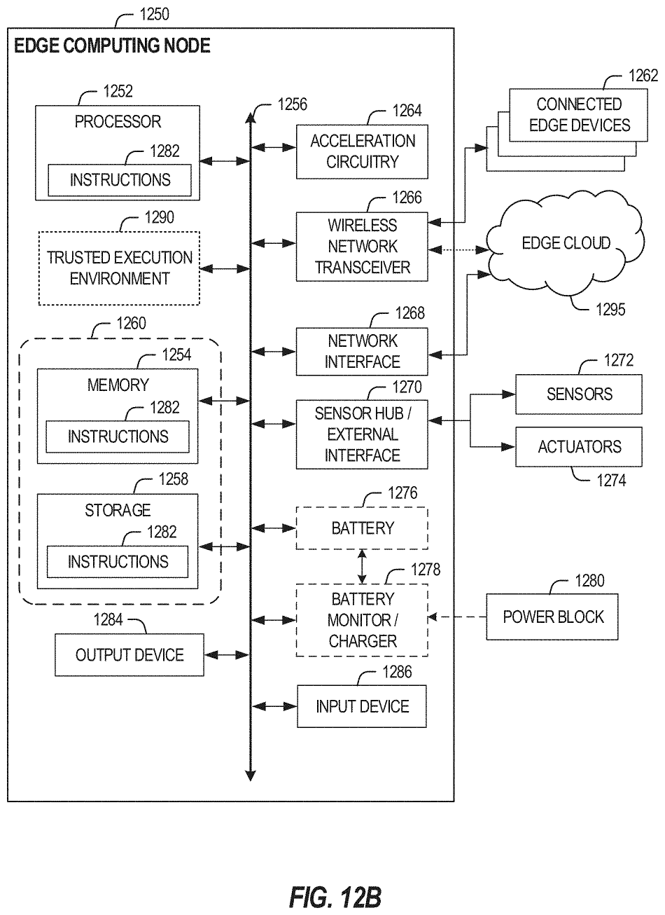

The network components of the edge cloud 710 may be servers, multi-tenant servers, appliance computing devices, and/or any other type of computing devices. For example, the edge cloud 710 may include an appliance computing device that is a self-contained electronic device including a housing, a chassis, a case or a shell. In some circumstances, the housing may be dimensioned for portability such that it can be carried by a human and/or shipped. Example housings may include materials that form one or more exterior surfaces that partially or fully protect contents of the appliance, in which protection may include weather protection, hazardous environment protection (e.g., EMI, vibration, extreme temperatures), and/or enable submergibility. Example housings may include power circuitry to provide power for stationary and/or portable implementations, such as AC power inputs, DC power inputs, AC/DC or DC/AC converter(s), power regulators, transformers, charging circuitry, batteries, wired inputs and/or wireless power inputs. Example housings and/or surfaces thereof may include or connect to mounting hardware to enable attachment to structures such as buildings, telecommunication structures (e.g., poles, antenna structures, etc.) and/or racks (e.g., server racks, blade mounts, etc.). Example housings and/or surfaces thereof may support one or more sensors (e.g., temperature sensors, vibration sensors, light sensors, acoustic sensors, capacitive sensors, proximity sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, propellers, etc.) and/or articulating hardware (e.g., robot arms, pivotable appendages, etc.). In some circumstances, the sensors may include any type of input devices such as user interface hardware (e.g., buttons, switches, dials, sliders, etc.). In some circumstances, example housings include output devices contained in, carried by, embedded therein and/or attached thereto. Output devices may include displays, touchscreens, lights, LEDs, speakers, I/O ports (e.g., USB), etc. In some circumstances, edge devices are devices presented in the network for a specific purpose (e.g., a traffic light), but may have processing and/or other capacities that may be utilized for other purposes. Such edge devices may be independent from other networked devices and may be provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. Example hardware for implementing an appliance computing device is described in conjunction with FIG. 12B. The edge cloud 710 may also include one or more servers and/or one or more multi-tenant servers. Such a server may include an operating system and implement a virtual computing environment. A virtual computing environment may include a hypervisor managing (e.g., spawning, deploying, destroying, etc.) one or more virtual machines, one or more containers, etc. Such virtual computing environments provide an execution environment in which one or more applications and/or other software, code or scripts may execute while being isolated from one or more other applications, software, code or scripts.

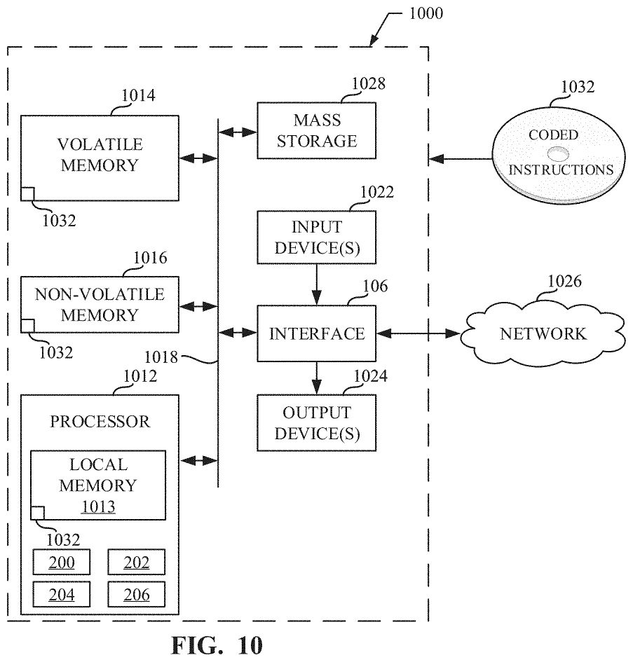

In FIG. 9, various client endpoints 910 (in the form of mobile devices, computers, autonomous vehicles, business computing equipment, industrial processing equipment) exchange requests and responses that are specific to the type of endpoint network aggregation. For instance, client endpoints 910 may obtain network access via a wired broadband network, by exchanging requests and responses 922 through an on-premise network system 932. Some client endpoints 910, such as mobile computing devices, may obtain network access via a wireless broadband network, by exchanging requests and responses 924 through an access point (e.g., cellular network tower) 934. Some client endpoints 910, such as autonomous vehicles may obtain network access for requests and responses 926 via a wireless vehicular network through a street-located network system 936. However, regardless of the type of network access, the TSP may deploy aggregation points 942, 944 within the edge cloud 710 to aggregate traffic and requests. Thus, within the edge cloud 710, the TSP may deploy various compute and storage resources, such as at edge aggregation nodes 940, to provide requested content. The edge aggregation nodes 940 and other systems of the edge cloud 710 are connected to a cloud or data center 960, which uses a backhaul network 950 to fulfill higher-latency requests from a cloud/data center for websites, applications, database servers, etc. Additional or consolidated instances of the edge aggregation nodes 940 and the aggregation points 942, 944, including those deployed on a single server framework, may also be present within the edge cloud 710 or other areas of the TSP infrastructure. In some examples, one or more of the cloud or data center 960, the aggregation nodes 940, and/or the systems 932, 934, 936 may implement the weight compressor 104 of FIG. 2 and one or more of the aggregation nodes 940, and/or the systems 932, 934, 936, and/or the endpoints 910 may implement the weight decompressor 114 of FIG. 3.

FIG. 10 is a block diagram of an example processor platform 1000 structured to execute the instructions of FIG. 4 to implement the example weight compressor 104 of FIGS. 1 and/or 2 The processor platform 1000 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, or any other type of computing device.

The processor platform 1000 of the illustrated example includes a processor 1012. The processor 1012 of the illustrated example is hardware. For example, the processor 1012 can be implemented by one or more integrated circuits, logic circuits, microprocessors, GPUs, DSPs, or controllers from any desired family or manufacturer. The hardware processor 1012 may be a semiconductor-based (e.g., silicon-based) device. In this example, the processor 1012 implements at least one of the example component interface 200, the example channel manipulator 202, the example comparator 204, and/or the example data packet generator 206 of FIG. 2.

The processor 1012 of the illustrated example includes a local memory 1013 (e.g., a cache). The processor 1012 of the illustrated example is in communication with a main memory including a volatile memory 1014 and a non-volatile memory 1016 via a bus 1018. The volatile memory 1014 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 1016 may be implemented by flash memory and/or any other desired type of memory device. Access to the main memory 1014, 1016 is controlled by a memory controller.

The processor platform 1000 of the illustrated example also includes an interface circuit 106. The interface circuit 106 may be implemented by any type of interface standard, such as an Ethernet interface, a universal serial bus (USB), a Bluetooth® interface, a near field communication (NFC) interface, and/or a PCI express interface.

In the illustrated example, one or more input devices 1022 are connected to the interface circuit 106. The input device(s) 1022 permit(s) a user to enter data and/or commands into the processor 1012. The input device(s) can be implemented by, for example, an audio sensor, a microphone, a camera (still or video), a keyboard, a button, a mouse, a touchscreen, a track-pad, a trackball, and/or a voice recognition system.

One or more output devices 1024 are also connected to the interface circuit 106 of the illustrated example. The output devices 1024 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, and/or speaker. The interface circuit 106 of the illustrated example, thus, typically includes a graphics driver card, a graphics driver chip and/or a graphics driver processor.

The interface circuit 106 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 1026. The communication can be via, for example, an Ethernet connection, a digital subscriber line (DSL) connection, a telephone line connection, a coaxial cable system, a satellite system, a line-of-site wireless system, a cellular system, etc.

The processor platform 1000 of the illustrated example also includes one or more mass storage devices 1028 for storing software and/or data. Examples of such mass storage devices 1028 include floppy disk drives, hard drive disks, compact disk drives, Blu-ray disk drives, redundant array of independent disks (RAID) systems, and digital versatile disk (DVD) drives. The example local memory 1013, the example volatile memory 1014, and/or the example non-volatile memory 1016, and/or the one or more mass storage devices 1028 can implement the example storage 108 of FIG. 1.

Machine executable instructions 1032 represented in FIG. 4 may be stored in the mass storage device 1028, in the volatile memory 1014, in the non-volatile memory 1016, and/or on a removable non-transitory computer readable storage medium such as a CD or DVD.

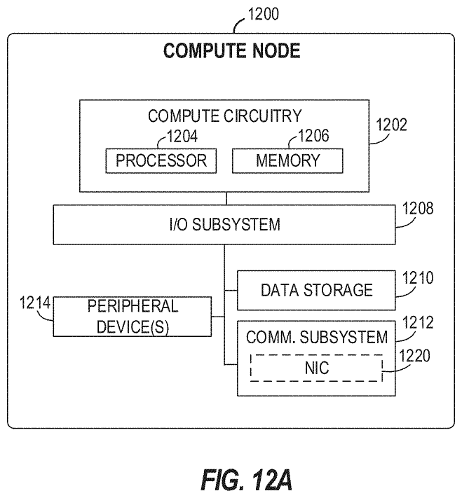

FIG. 11 is a block diagram of an example processor platform 1100 structured to execute the instructions of FIG. 5 to implement the example weight decompressor 114 of FIGS. 1 and/or 3 The processor platform 1100 can be, for example, a server, a personal computer, a workstation, a self-learning machine (e.g., a neural network), a mobile device (e.g., a cell phone, a smart phone, a tablet such as an iPad™), a personal digital assistant (PDA), a wearable device, an Internet appliance, or any other type of computing device.

The processor platform 1100 of the illustrated example includes a processor 1112. The processor 1112 of the illustrated example is hardware. For example, the processor 1112 can be implemented by one or more integrated circuits, logic circuits, microprocessors, GPUs, DSPs, or controllers from any desired family or manufacturer. The hardware processor 1112 may be a semiconductor-based (e.g., silicon-based) device. In this example, the processor 1112 implements at least one of the example component interface 210, the example data packet analyzer 212, and/or the example weight applicator 216 of FIG. 3.

The processor 1112 of the illustrated example includes a local memory 1113 (e.g., a cache). The processor 1112 of the illustrated example is in communication with a main memory including a volatile memory 1114 and a non-volatile memory 1116 via a bus 1118. The volatile memory 1114 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 1116 may be implemented by flash memory and/or any other desired type of memory device. Access to the main memory 1114, 1116 is controlled by a memory controller.

The processor platform 1100 of the illustrated example also includes an interface circuit 122. The interface circuit 122 may be implemented by any type of interface standard, such as an Ethernet interface, a universal serial bus (USB), a Bluetooth® interface, a near field communication (NFC) interface, and/or a PCI express interface.

In the illustrated example, one or more input devices 1122 are connected to the interface circuit 122. The input device(s) 1122 permit(s) a user to enter data and/or commands into the processor 1112. The input device(s) can be implemented by, for example, an audio sensor, a microphone, a camera (still or video), a keyboard, a button, a mouse, a touchscreen, a track-pad, a trackball, and/or a voice recognition system.

One or more output devices 1124 are also connected to the interface circuit 122 of the illustrated example. The output devices 1124 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, and/or speaker. The interface circuit 122 of the illustrated example, thus, typically includes a graphics driver card, a graphics driver chip and/or a graphics driver processor.

The interface circuit 122 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 1126. The communication can be via, for example, an Ethernet connection, a digital subscriber line (DSL) connection, a telephone line connection, a coaxial cable system, a satellite system, a line-of-site wireless system, a cellular system, etc.

The processor platform 1100 of the illustrated example also includes one or more mass storage devices 1128 for storing software and/or data. Examples of such mass storage devices 1128 include floppy disk drives, hard drive disks, compact disk drives, Blu-ray disk drives, redundant array of independent disks (RAID) systems, and digital versatile disk (DVD) drives. The example local memory 1113, the example volatile memory 1114, and/or the example non-volatile memory 1116, and/or the one or more mass storage devices 1128 can implement the example storage 214 of FIG. 1.

Machine executable instructions 1132 represented in FIG. 5 may be stored in the mass storage device 1128, in the volatile memory 1114, in the non-volatile memory 1116, and/or on a removable non-transitory computer readable storage medium such as a CD or DVD.

In further examples, any of the compute nodes or devices discussed with reference to the present edge computing systems and environment may be fulfilled based on the components depicted in FIGS. 12A and 12B. Respective edge compute nodes may be embodied as a type of device, appliance, computer, or other “thing” capable of communicating with other edge, networking, or endpoint components. For example, an edge compute device may be embodied as a personal computer, server, smartphone, a mobile compute device, a smart appliance, an in-vehicle compute system (e.g., a navigation system), a self-contained device having an outer case, shell, etc., or other device or system capable of performing the described functions.

In the simplified example depicted in FIG. 12A, an edge compute node 1200 includes a compute engine (also referred to herein as “compute circuitry”) 1202, an input/output (I/O) subsystem 1208, data storage 1210, a communication circuitry subsystem 1212, and, optionally, one or more peripheral devices 1214. In other examples, respective compute devices may include other or additional components, such as those typically found in a computer (e.g., a display, peripheral devices, etc.). Additionally, in some examples, one or more of the illustrative components may be incorporated in, or otherwise form a portion of, another component.

The compute node 1200 may be embodied as any type of engine, device, or collection of devices capable of performing various compute functions. In some examples, the compute node 1200 may be embodied as a single device such as an integrated circuit, an embedded system, a field-programmable gate array (FPGA), a system-on-a-chip (SOC), or other integrated system or device. In the illustrative example, the compute node 1200 includes or is embodied as a processor 1204 and a memory 1206. The processor 1204 may be embodied as any type of processor capable of performing the functions described herein (e.g., executing an application). For example, the processor 1204 may be embodied as a multi-core processor(s), a microcontroller, a processing unit, a specialized or special purpose processing unit, or other processor or processing/controlling circuit. In some examples, the processor 1204 implements the example weight compressor 104 and/or the example weight decompressor 114 of FIGS. 2 and/or 3.

In some examples, the processor 1204 may be embodied as, include, or be coupled to an FPGA, an application specific integrated circuit (ASIC), reconfigurable hardware or hardware circuitry, or other specialized hardware to facilitate performance of the functions described herein. Also in some examples, the processor 704 may be embodied as a specialized x-processing unit (xPU) also known as a data processing unit (DPU), infrastructure processing unit (IPU), or network processing unit (NPU). Such an xPU may be embodied as a standalone circuit or circuit package, integrated within an SOC, or integrated with networking circuitry (e.g., in a SmartNIC, or enhanced SmartNIC), acceleration circuitry, storage devices, or AI hardware (e.g., GPUs or programmed FPGAs). Such an xPU may be designed to receive programming to process one or more data streams and perform specific tasks and actions for the data streams (such as hosting microservices, performing service management or orchestration, organizing or managing server or data center hardware, managing service meshes, or collecting and distributing telemetry), outside of the CPU or general purpose processing hardware. However, it will be understood that a xPU, a SOC, a CPU, and other variations of the processor 1204 may work in coordination with each other to execute many types of operations and instructions within and on behalf of the compute node 1200.

The memory 1206 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM).

In an example, the memory device is a block addressable memory device, such as those based on NAND or NOR technologies. A memory device may also include a three dimensional crosspoint memory device (e.g., Intel® 3D XPoint™ memory), or other byte addressable write-in-place nonvolatile memory devices. The memory device may refer to the die itself and/or to a packaged memory product. In some examples, 3D crosspoint memory (e.g., Intel® 3D XPoint™ memory) may comprise a transistor-less stackable cross point architecture in which memory cells sit at the intersection of word lines and bit lines and are individually addressable and in which bit storage is based on a change in bulk resistance. In some examples, all or a portion of the memory 1206 may be integrated into the processor 1204. The memory 1206 may store various software and data used during operation such as one or more applications, data operated on by the application(s), libraries, and drivers.

The compute circuitry 1202 is communicatively coupled to other components of the compute node 1200 via the I/O subsystem 1208, which may be embodied as circuitry and/or components to facilitate input/output operations with the compute circuitry 1202 (e.g., with the processor 1204 and/or the main memory 1206) and other components of the compute circuitry 1202. For example, the I/O subsystem 1208 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 1208 may form a portion of a system-on-a-chip (SoC) and be incorporated, along with one or more of the processor 1204, the memory 1206, and other components of the compute circuitry 1202, into the compute circuitry 1202.

The one or more illustrative data storage devices 1210 may be embodied as any type of devices configured for short-term or long-term storage of data such as, for example, memory devices and circuits, memory cards, hard disk drives, solid-state drives, or other data storage devices. Individual data storage devices 1210 may include a system partition that stores data and firmware code for the data storage device 1210. Individual data storage devices 1210 may also include one or more operating system partitions that store data files and executables for operating systems depending on, for example, the type of compute node 1200.

The communication circuitry 1212 may be embodied as any communication circuit, device, or collection thereof, capable of enabling communications over a network between the compute circuitry 1202 and another compute device (e.g., an edge gateway of an implementing edge computing system). The communication circuitry 1212 may be configured to use any one or more communication technology (e.g., wired or wireless communications) and associated protocols (e.g., a cellular networking protocol such a 3GPP 4G or 5G standard, a wireless local area network protocol such as IEEE 802.11/Wi-Fi, a wireless wide area network protocol, Ethernet, Bluetooth®, Bluetooth Low Energy, a IoT protocol such as IEEE 802.15.4 or ZigBee®, low-power wide-area network (LPWAN) or low-power wide-area (LPWA) protocols, etc.) to effect such communication.

The illustrative communication circuitry 1212 includes a network interface controller (NIC) 1220, which may also be referred to as a host fabric interface (HFI). The NIC 1220 may be embodied as one or more add-in-boards, daughter cards, network interface cards, controller chips, chipsets, or other devices that may be used by the compute node 1200 to connect with another compute device (e.g., an edge gateway node). In some examples, the NIC 1220 may be embodied as part of a system-on-a-chip (SoC) that includes one or more processors, or included on a multichip package that also contains one or more processors. In some examples, the NIC 1220 may include a local processor (not shown) and/or a local memory (not shown) that are both local to the NIC 1220. In such examples, the local processor of the NIC 1220 may be capable of performing one or more of the functions of the compute circuitry 1202 described herein. Additionally, or alternatively, in such examples, the local memory of the NIC 1220 may be integrated into one or more components of the client compute node at the board level, socket level, chip level, and/or other levels.

Additionally, in some examples, a respective compute node 1200 may include one or more peripheral devices 1214. Such peripheral devices 1214 may include any type of peripheral device found in a compute device or server such as audio input devices, a display, other input/output devices, interface devices, and/or other peripheral devices, depending on the particular type of the compute node 1200. In further examples, the compute node 1200 may be embodied by a respective edge compute node (whether a client, gateway, or aggregation node) in an edge computing system or like forms of appliances, computers, subsystems, circuitry, or other components.

In a more detailed example, FIG. 12B illustrates a block diagram of an example of components that may be present in an edge computing node 1250 for implementing the techniques (e.g., operations, processes, methods, and methodologies) described herein. This edge computing node 1250 provides a closer view of the respective components of node 1200 when implemented as or as part of a computing device (e.g., as a mobile device, a base station, server, gateway, etc.). The edge computing node 1250 may include any combinations of the hardware or logical components referenced herein, and it may include or couple with any device usable with an edge communication network or a combination of such networks. The components may be implemented as integrated circuits (ICs), portions thereof, discrete electronic devices, or other modules, instruction sets, programmable logic or algorithms, hardware, hardware accelerators, software, firmware, or a combination thereof adapted in the edge computing node 1250, or as components otherwise incorporated within a chassis of a larger system.

The edge computing device 1250 may include processing circuitry in the form of a processor 1252, which may be a microprocessor, a multi-core processor, a multithreaded processor, an ultra-low voltage processor, an embedded processor, an xPU/DPU/IPU/NPU, special purpose processing unit, specialized processing unit, or other known processing elements. The processor 1252 may be a part of a system on a chip (SoC) in which the processor 1252 and other components are formed into a single integrated circuit, or a single package, such as the Edison™ or Galileo™ SoC boards from Intel Corporation, Santa Clara, Calif. As an example, the processor 1252 may include an Intel® Architecture Core™ based CPU processor, such as a Quark™, an Atom™, an i3, an i5, an i7, an i9, or an MCU-class processor, or another such processor available from Intel®. However, any number other processors may be used, such as available from Advanced Micro Devices, Inc. (AMD®) of Sunnyvale, Calif., a MIPS®-based design from MIPS Technologies, Inc. of Sunnyvale, Calif., an ARM®-based design licensed from ARM Holdings, Ltd. or a customer thereof, or their licensees or adopters. The processors may include units such as an A5-A13 processor from Apple® Inc., a Snapdragon™ processor from Qualcomm® Technologies, Inc., or an OMAP™ processor from Texas Instruments, Inc. The processor 1252 and accompanying circuitry may be provided in a single socket form factor, multiple socket form factor, or a variety of other formats, including in limited hardware configurations or configurations that include fewer than all elements shown in FIG. 12B. In some examples, the processor 1252 implements the example weight compressor 104 and/or the example weight decompressor 114 of FIGS. 2 and/or 3.

The processor 1252 may communicate with a system memory 1254 over an interconnect 1256 (e.g., a bus). Any number of memory devices may be used to provide for a given amount of system memory. As examples, the memory 754 may be random access memory (RAM) in accordance with a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 1258 may also couple to the processor 1252 via the interconnect 1256. In an example, the storage 1258 may be implemented via a solid-state disk drive (SSDD). Other devices that may be used for the storage 1258 include flash memory cards, such as Secure Digital (SD) cards, microSD cards, eXtreme Digital (XD) picture cards, and the like, and Universal Serial Bus (USB) flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

In low power implementations, the storage 1258 may be on-die memory or registers associated with the processor 1252. However, in some examples, the storage 1258 may be implemented using a micro hard disk drive (HDD). Further, any number of new technologies may be used for the storage 1258 in addition to, or instead of, the technologies described, such resistance change memories, phase change memories, holographic memories, or chemical memories, among others.

The components may communicate over the interconnect 1256. The interconnect 1256 may include any number of technologies, including industry standard architecture (ISA), extended ISA (EISA), peripheral component interconnect (PCI), peripheral component interconnect extended (PCIx), PCI express (PCIe), or any number of other technologies. The interconnect 1256 may be a proprietary bus, for example, used in an SoC based system. Other bus systems may be included, such as an Inter-Integrated Circuit (I2C) interface, a Serial Peripheral Interface (SPI) interface, point to point interfaces, and a power bus, among others.

The interconnect 1256 may couple the processor 1252 to a transceiver 1266, for communications with the connected edge devices 1262. The transceiver 1266 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected edge devices 1262. For example, a wireless local area network (WLAN) unit may be used to implement Wi-Fi® communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The wireless network transceiver 1266 (or multiple transceivers) may communicate using multiple standards or radios for communications at a different range. For example, the edge computing node 1250 may communicate with close devices, e.g., within about 10 meters, using a local transceiver based on Bluetooth Low Energy (BLE), or another low power radio, to save power. More distant connected edge devices 1262, e.g., within about 50 meters, may be reached over ZigBee® or other intermediate power radios. Both communications techniques may take place over a single radio at different power levels or may take place over separate transceivers, for example, a local transceiver using BLE and a separate mesh transceiver using ZigBee®.

A wireless network transceiver 1266 (e.g., a radio transceiver) may be included to communicate with devices or services in a cloud (e.g., an edge cloud 1295) via local or wide area network protocols. The wireless network transceiver 1266 may be a low-power wide-area (LPWA) transceiver that follows the IEEE 802.15.4, or IEEE 802.15.4g standards, among others. The edge computing node 1250 may communicate over a wide area using LoRaWAN™ (Long Range Wide Area Network) developed by Semtech and the LoRa Alliance. The techniques described herein are not limited to these technologies but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the wireless network transceiver 1266, as described herein. For example, the transceiver 1266 may include a cellular transceiver that uses spread spectrum (SPA/SAS) communications for implementing high-speed communications. Further, any number of other protocols may be used, such as Wi-Fi® networks for medium speed communications and provision of network communications. The transceiver 1266 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 1268 may be included to provide a wired communication to nodes of the edge cloud 1295 or to other devices, such as the connected edge devices 1262 (e.g., operating in a mesh). The wired communication may provide an Ethernet connection or may be based on other types of networks, such as Controller Area Network (CAN), Local Interconnect Network (LIN), DeviceNet, ControlNet, Data Highway+, PROFIBUS, or PROFINET, among many others. An additional NIC 1268 may be included to enable connecting to a second network, for example, a first NIC 1268 providing communications to the cloud over Ethernet, and a second NIC 1268 providing communications to other devices over another type of network.

Given the variety of types of applicable communications from the device to another component or network, applicable communications circuitry used by the device may include or be embodied by any one or more of components 1264, 1266, 1268, or 1270. Accordingly, in various examples, applicable means for communicating (e.g., receiving, transmitting, etc.) may be embodied by such communications circuitry.

The edge computing node 1250 may include or be coupled to acceleration circuitry 1264, which may be embodied by one or more artificial intelligence (AI) accelerators, a neural compute stick, neuromorphic hardware, an FPGA, an arrangement of GPUs, an arrangement of xPUs/DPUs/IPU/NPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. These tasks also may include the specific edge computing tasks for service management and service operations discussed elsewhere in this document.

The interconnect 1256 may couple the processor 1252 to a sensor hub or external interface 1270 that is used to connect additional devices or subsystems. The devices may include sensors 1272, such as accelerometers, level sensors, flow sensors, optical light sensors, camera sensors, temperature sensors, global navigation system (e.g., GPS) sensors, pressure sensors, barometric pressure sensors, and the like. The hub or interface 1270 further may be used to connect the edge computing node 1250 to actuators 1274, such as power switches, valve actuators, an audible sound generator, a visual warning device, and the like.

In some optional examples, various input/output (I/O) devices may be present within or connected to, the edge computing node 1250. For example, a display or other output device 1284 may be included to show information, such as sensor readings or actuator position. An input device 1286, such as a touch screen or keypad may be included to accept input. An output device 1284 may include any number of forms of audio or visual display, including simple visual outputs such as binary status indicators (e.g., light-emitting diodes (LEDs)) and multi-character visual outputs, or more complex outputs such as display screens (e.g., liquid crystal display (LCD) screens), with the output of characters, graphics, multimedia objects, and the like being generated or produced from the operation of the edge computing node 1250. A display or console hardware, in the context of the present system, may be used to provide output and receive input of an edge computing system; to manage components or services of an edge computing system; identify a state of an edge computing component or service; or to conduct any other number of management or administration functions or service use cases.

A battery 1276 may power the edge computing node 1250, although, in examples in which the edge computing node 1250 is mounted in a fixed location, it may have a power supply coupled to an electrical grid, or the battery may be used as a backup or for temporary capabilities. The battery 1276 may be a lithium ion battery, or a metal-air battery, such as a zinc-air battery, an aluminum-air battery, a lithium-air battery, and the like.

A battery monitor/charger 1278 may be included in the edge computing node 1250 to track the state of charge (SoCh) of the battery 1276, if included. The battery monitor/charger 1278 may be used to monitor other parameters of the battery 1276 to provide failure predictions, such as the state of health (SoH) and the state of function (SoF) of the battery 1276. The battery monitor/charger 1278 may include a battery monitoring integrated circuit, such as an LTC4020 or an LTC2990 from Linear Technologies, an ADT7488A from ON Semiconductor of Phoenix Ariz., or an IC from the UCD90xxx family from Texas Instruments of Dallas, Tex. The battery monitor/charger 1278 may communicate the information on the battery 1276 to the processor 1252 over the interconnect 1256. The battery monitor/charger 1278 may also include an analog-to-digital (ADC) converter that enables the processor 1252 to directly monitor the voltage of the battery 1276 or the current flow from the battery 1276. The battery parameters may be used to determine actions that the edge computing node 1250 may perform, such as transmission frequency, mesh network operation, sensing frequency, and the like.

A power block 1280, or other power supply coupled to a grid, may be coupled with the battery monitor/charger 1278 to charge the battery 1276. In some examples, the power block 1280 may be replaced with a wireless power receiver to obtain the power wirelessly, for example, through a loop antenna in the edge computing node 1250. A wireless battery charging circuit, such as an LTC4020 chip from Linear Technologies of Milpitas, Calif., among others, may be included in the battery monitor/charger 1278. The specific charging circuits may be selected based on the size of the battery 1276, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 1258 may include instructions 1282 in the form of software, firmware, or hardware commands to implement the techniques described herein. Although such instructions 1282 are shown as code blocks included in the memory 1254 and the storage 1258, it may be understood that any of the code blocks may be replaced with hardwired circuits, for example, built into an application specific integrated circuit (ASIC).

In an example, the instructions 1282 provided via the memory 1254, the storage 1258, or the processor 1252 may be embodied as a non-transitory, machine-readable medium 1260 including code to direct the processor 1252 to perform electronic operations in the edge computing node 1250. The processor 1252 may access the non-transitory, machine-readable medium 1260 over the interconnect 1256. For instance, the non-transitory, machine-readable medium 1260 may be embodied by devices described for the storage 1258 or may include specific storage units such as optical disks, flash drives, or any number of other hardware devices. The non-transitory, machine-readable medium 1260 may include instructions to direct the processor 1252 to perform a specific sequence or flow of actions, for example, as described with respect to the flowchart(s) and block diagram(s) of operations and functionality depicted above. As used herein, the terms “machine-readable medium” and “computer-readable medium” are interchangeable.

Also in a specific example, the instructions 1282 on the processor 1252 (separately, or in combination with the instructions 1282 of the machine readable medium 1260) may configure execution or operation of a trusted execution environment (TEE) 1290. In an example, the TEE 1290 operates as a protected area accessible to the processor 1252 for secure execution of instructions and secure access to data. Various implementations of the TEE 1290, and an accompanying secure area in the processor 1252 or the memory 1254 may be provided, for instance, through use of Intel Software Guard Extensions (SGX) or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the device 1250 through the TEE 1290 and the processor 1252.

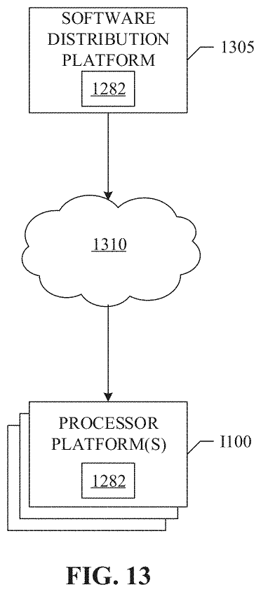

FIG. 13 illustrates an example software distribution platform 1305 to distribute software, such as the example computer readable instructions 1282 of FIG. 12, to one or more devices, such as example processor platform(s) 1300 and/or example connected edge devices 1250. The example software distribution platform 1305 may be implemented by any computer server, data facility, cloud service, etc., capable of storing and transmitting software to other computing devices (e.g., third parties, the example connected edge devices 1250 of FIG. 12). Example connected edge devices may be customers, clients, managing devices (e.g., servers), third parties (e.g., customers of an entity owning and/or operating the software distribution platform 1305). Example connected edge devices may operate in commercial and/or home automation environments. In some examples, a third party is a developer, a seller, and/or a licensor of software such as the example computer readable instructions 1282 of FIG. 12. The third parties may be consumers, users, retailers, OEMs, etc. that purchase and/or license the software for use and/or re-sale and/or sub-licensing. In some examples, distributed software causes display of one or more user interfaces (UIs) and/or graphical user interfaces (GUIs) to identify the one or more devices (e.g., connected edge devices) geographically and/or logically separated from each other (e.g., physically separated IoT devices chartered with the responsibility of water distribution control (e.g., pumps), electricity distribution control (e.g., relays), etc.).

In the illustrated example of FIG. 13, the software distribution platform 1305 includes one or more servers and one or more storage devices. The storage devices store the computer readable instructions 1282, which may correspond to the example computer readable instructions 400, 500 of FIGS. 4 and/or 5, as described above. The one or more servers of the example software distribution platform 1305 are in communication with a network 1310, which may correspond to any one or more of the Internet and/or any of the example networks 1126 described above. In some examples, the one or more servers are responsive to requests to transmit the software to a requesting party as part of a commercial transaction. Payment for the delivery, sale and/or license of the software may be handled by the one or more servers of the software distribution platform and/or via a third-party payment entity. The servers enable purchasers and/or licensors to download the computer readable instructions 1282 from the software distribution platform 1305. For example, the software, which may correspond to the example computer readable instructions 400, 500 of FIGS. 4 and/or 5, may be downloaded to the example processor platform(s) 1300 (e.g., example connected edge devices), which is/are to execute the computer readable instructions 1282 to implement the weight compressor 104 and/or the weight decompressor 114 of FIGS. 1-3. In some examples, one or more servers of the software distribution platform 1305 are communicatively connected to one or more security domains and/or security devices through which requests and transmissions of the example computer readable instructions 1282 must pass. In some examples, one or more servers of the software distribution platform 1305 periodically offer, transmit, and/or force updates to the software (e.g., the example computer readable instructions 1282 of FIG. 12) to ensure improvements, patches, updates, etc. are distributed and applied to the software at the end user devices.

In the illustrated example of FIG. 13, the computer readable instructions 1282 are stored on storage devices of the software distribution platform 1305 in a particular format. A format of computer readable instructions includes, but is not limited to a particular code language (e.g., Java, JavaScript, Python, C, C#, SQL, HTML, etc.), and/or a particular code state (e.g., uncompiled code (e.g., ASCII), interpreted code, linked code, executable code (e.g., a binary), etc.). In some examples, the computer readable instructions 1282 stored in the software distribution platform 1305 are in a first format when transmitted to the example processor platform(s) 1300. In some examples, the first format is an executable binary in which particular types of the processor platform(s) 1300 can execute. However, in some examples, the first format is uncompiled code that requires one or more preparation tasks to transform the first format to a second format to enable execution on the example processor platform(s) 1300. For instance, the receiving processor platform(s) 1300 may need to compile the computer readable instructions 1282 in the first format to generate executable code in a second format that is capable of being executed on the processor platform(s) 1300. In still other examples, the first format is interpreted code that, upon reaching the processor platform(s) 1300, is interpreted by an interpreter to facilitate execution of instructions.

Example methods, apparatus, systems, and articles of manufacture to compress weights of an artificial intelligence model are disclosed herein. Further examples and combinations thereof include the following: Example 1 includes an apparatus to compress data packets corresponding to a model, the apparatus comprising a channel manipulator to manipulate weights of a channel of a trained model to generate a manipulated channel, a comparator to determine a similarity between (a) at least one of the channel or the manipulated channel and (b) a reference channel, and a data packet generator to, when the similarity satisfies a similarity threshold, generate a compressed data packet based on a difference between (a) the at least one of the channel or the manipulated channel and (b) the reference channel.

Example 2 includes the apparatus of example 1, wherein the channel manipulator is to manipulate the weights by at least one of moving the weights within the channel, rotating the weights within the channel, inverting the weights, or flipping the weights within the channel.

Example 3 includes the apparatus of example 1, wherein the comparator is to determine the similarity using a statistical similarity operation.

Example 4 includes the apparatus of example 3, wherein the statistical similarity operation is a sum of an absolution difference operation.

Example 5 includes the apparatus of example 1, wherein the comparator is to select at least one of the channel or the manipulated channel based on the similarity that is highest, and the data packet generator is to generate the compressed data based on the selected channel.

Example 6 includes the apparatus of example 1, wherein the reference channel is a previously processed channel of the trained model.

Example 10 includes the apparatus of example 1, wherein the compressed data packet includes a value indicative of the reference channel and a value indicative of a manipulation of the manipulated weights.

Example 11 includes the apparatus of example 1, wherein the compressed data packet includes the weights in the channel in a compressed format.

Example 9 includes an apparatus to decompress data packets corresponding to a model, the apparatus comprising storage to store first weights of a reference channel, a data packet analyzer to decode a data packet to identify (a) a channel to implement in a model, (b) the reference channel, and (c) a difference value corresponding to a difference between second weights of the channel and the first weights of the reference channel, and a weight applicator to access the first weights of the reference channel, adjust the first weights of the reference channel based on the difference value to generate third weights, and implement the third weights at the channel in the model.

Example 10 includes the apparatus of example 9, wherein the reference channel corresponds to a previously decoded data packet corresponding to the model.

Example 11 includes the apparatus of example 9, wherein the data packet analyzer is to decode the data packet to identify a manipulation of the second weights of the channel.

Example 12 includes the apparatus of example 11, wherein the weight applicator is to manipulate adjusted first weights based on the manipulation to generate the third weights.

Example 13 includes the apparatus of example 12, wherein the manipulation corresponds to at least one of a shift of adjusted first weights, a rotation of the adjusted first weights within the channel, an inversion of the adjusted first weights, or flipping of the adjusted first weights within the channel.

Example 14 includes the apparatus of example 11, the weight applicator is to implement the third weights by applying the third weights to neurons of a neural network.

Example 15 includes the apparatus of example 14, wherein the neural network is to implement the model.

Example 16 includes the apparatus of example 11, wherein the weight applicator is to store the third weights in conjunction with the channel in the storage.

Example 17 includes a non-transitory computer readable storage medium comprising instruction which, when executed, cause one or more processors to at least manipulate weights of a channel of a trained model to generate a manipulated channel, determine a similarity between (a) at least one of the channel or the manipulated channel and (b) a reference channel, and when the similarity satisfies a similarity threshold, generate a compressed data packet based on a difference between (a) the at least one of the channel or the manipulated channel and (b) the reference channel.

Example 18 includes the computer readable storage of example 17, wherein the instructions cause the one or more processors to manipulate the weights by at least one of moving the weights within the channel, rotating the weights within the channel, inverting the weights, or flipping the weights within the channel.

Example 19 includes the computer readable storage of example 17, wherein the instructions cause the one or more processors to determine the similarity using a statistical similarity operation.

Example 20 includes the computer readable storage of example 19, wherein the statistical similarity operation is a sum of an absolution difference operation.

Example 21 includes the computer readable storage of example 17, wherein the instructions cause the one or more processors to select at least one of the channel or the manipulated channel based on the similarity that is highest, and generate the compressed data based on the selected channel.

Example 22 includes the computer readable storage of example 17, wherein the reference channel is a previously processed channel of the trained model.

Example 23 includes the computer readable storage of example 17, wherein the compressed data packet includes a value indicative of the reference channel and a value indicative of a manipulation of the manipulated weights.

Example 24 includes the computer readable storage of example 17, wherein the compressed data packet includes the weights in the channel in a compressed format.

Example 25 includes a non-transitory computer readable storage medium comprising instruction which, when executed, cause one or more processors to at least store first weights of a reference channel, decode a data packet to identify (a) a channel to implement in a model, (b) the reference channel, and (c) a difference value corresponding to a difference between second weights of the channel and the first weights of the reference channel, access the first weights of the reference channel, adjust the first weights of the reference channel based on the difference value to generate third weights, and implement the third weights at the channel in the model.

Example 26 includes the computer readable storage of example 25, wherein the reference channel corresponds to a previously decoded data packet corresponding to the model.

Example 27 includes the computer readable storage of example 25, wherein the instructions cause the one or more processors to decode the data packet to identify a manipulation of the second weights of the channel.

Example 28 includes the computer readable storage of example 27, wherein the instructions cause the one or more processors to manipulate adjusted first weights based on the manipulation to generate the third weights.

Example 29 includes the computer readable storage of example 28, wherein the manipulation corresponds to at least one of a shift of adjusted first weights, a rotation of the adjusted first weights within the channel, an inversion of the adjusted first weights, or flipping of the adjusted first weights within the channel.

Example 30 includes the computer readable storage of example 25, wherein the instructions cause the one or more processors to implement the third weights by applying the third weights to neurons of a neural network.

Example 31 includes the computer readable storage of example 30, wherein the instructions cause the one or more processors to implement the model in the neural network.

Example 32 includes the computer readable storage of example 25, wherein the instructions cause the one or more processors to store the third weights in conjunction with the channel in storage.

Example 33 includes a method to compress data packets corresponding to a model, the method comprising manipulating, by executing an instruction with a processor, weights of a channel of a trained model to generate a manipulated channel, determining, by executing an instruction with the processor, a similarity between (a) at least one of the channel or the manipulated channel and (b) a reference channel, and when the similarity satisfies a similarity threshold, generating, by executing an instruction with the processor, a compressed data packet based on a difference between (a) the at least one of the channel or the manipulated channel and (b) the reference channel.

Example 34 includes the method of example 33, wherein the manipulating of the weights includes at least one of moving the weights within the channel, rotating the weights within the channel, inverting the weights, or flipping the weights within the channel.

Example 35 includes the method of example 33, wherein the determining of the similarity includes using a statistical similarity operation.

Example 36 includes the method of example 35, wherein the statistical similarity operation is a sum of an absolution difference operation.

Example 37 includes the method of example 33, further including selecting at least one of the channel or the manipulated channel based on the similarity that is highest, the generating of the compressed data being based on the selected channel.

Example 38 includes the method of example 33, wherein the reference channel is a previously processed channel of the trained model.

Example 39 includes the method of example 33, wherein the compressed data packet includes a value indicative of the reference channel and a value indicative of a manipulation of the manipulated weights.

Example 40 includes the method of example 33, wherein the compressed data packet includes the weights in the channel in a compressed format.

Example 41 includes a method to decompress data packets corresponding to a model, the method comprising storing first weights of a reference channel, decoding, by executing an instruction with a processor, a data packet to identify (a) a channel to implement in a model, (b) the reference channel, and (c) a difference value corresponding to a difference between second weights of the channel and the first weights of the reference channel, accessing the first weights of the reference channel, adjusting, by executing an instruction with the processor, the first weights of the reference channel based on the difference value to generate third weights, and implementing the third weights at the channel in the model.

Example 42 includes the method of example 41, wherein the reference channel corresponds to a previously decoded data packet corresponding to the model.

Example 43 includes the method of example 41, wherein the decoding of the data packet identifies a manipulation of the second weights of the channel.

Example 44 includes the method of example 43, further including manipulating adjusted first weights based on the manipulation to generate the third weights.

Example 45 includes the method of example 44, wherein the manipulation corresponds to at least one of a shift of adjusted first weights, a rotation of the adjusted first weights within the channel, an inversion of the adjusted first weights, or flipping of the adjusted first weights within the channel.

Example 46 includes the method of example 41, the implementing of the third weights includes applying the third weights to neurons of a neural network.

Example 47 includes the method of example 46, wherein the neural network is to implement the model.

Example 48 includes the method of example 41, further including storing the third weights in conjunction with the channel in storage.

From the foregoing, it will be appreciated that example methods, apparatus and articles of manufacture have been disclosed that compress weights of an artificial intelligence model. Examples disclosed herein leverage temporal similarities between channels of weights of a trained neural network to compress channel data based on the difference. In this manner, the wireless bandwidth, memory bandwidth, memory size, and processor resources needed to deploy and implement a trained network is reduced. Thus, the disclosed methods, apparatus and articles of manufacture are accordingly directed to one or more improvement(s) in the functioning of a computer.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

The following claims are hereby incorporated into this Detailed Description by this reference, with each claim standing on its own as a separate embodiment of the present disclosure.

1. An apparatus to compress data packets corresponding to a model, the apparatus comprising:
a channel manipulator to manipulate weights of a channel of a trained model to generate a manipulated channel;
a comparator to determine a similarity between (a) at least one of the channel or the manipulated channel and (b) a reference channel; and
a data packet generator to, when the similarity satisfies a similarity threshold, generate a compressed data packet based on a difference between (a) the at least one of the channel or the manipulated channel and (b) the reference channel.

2. The apparatus of claim 1, wherein the channel manipulator is to manipulate the weights by at least one of moving the weights within the channel, rotating the weights within the channel, inverting the weights, or flipping the weights within the channel.

3. The apparatus of claim 1, wherein the comparator is to determine the similarity using a statistical similarity operation.

4. The apparatus of claim 3, wherein the statistical similarity operation is a sum of an absolution difference operation.

5. The apparatus of claim 1, wherein:
the comparator is to select at least one of the channel or the manipulated channel based on the similarity that is highest; and
the data packet generator is to generate the compressed data based on the selected channel.

6. The apparatus of claim 1, wherein the reference channel is a previously processed channel of the trained model.

7. The apparatus of claim 1, wherein the compressed data packet includes a value indicative of the reference channel and a value indicative of a manipulation of the manipulated weights.

8. The apparatus of claim 1, wherein the compressed data packet includes the weights in the channel in a compressed format.

9. (canceled)

10. (canceled)

11. (canceled)

12. (canceled)

13. (canceled)

14. (canceled)

15. (canceled)

16. (canceled)

17. A non-transitory computer readable storage medium comprising instruction which, when executed, cause one or more processors to at least:
manipulate weights of a channel of a trained model to generate a manipulated channel;
determine a similarity between (a) at least one of the channel or the manipulated channel and (b) a reference channel; and
when the similarity satisfies a similarity threshold, generate a compressed data packet based on a difference between (a) the at least one of the channel or the manipulated channel and (b) the reference channel.

18. The computer readable storage of claim 17, wherein the instructions cause the one or more processors to manipulate the weights by at least one of moving the weights within the channel, rotating the weights within the channel, inverting the weights, or flipping the weights within the channel.

19. The computer readable storage of claim 17, wherein the instructions cause the one or more processors to determine the similarity using a statistical similarity operation.

20. The computer readable storage of claim 19, wherein the statistical similarity operation is a sum of an absolution difference operation.

21. The computer readable storage of claim 17, wherein the instructions cause the one or more processors to:
select at least one of the channel or the manipulated channel based on the similarity that is highest; and
generate the compressed data based on the selected channel.

22. The computer readable storage of claim 17, wherein the reference channel is a previously processed channel of the trained model.

23. The computer readable storage of claim 17, wherein the compressed data packet includes a value indicative of the reference channel and a value indicative of a manipulation of the manipulated weights.

24. The computer readable storage of claim 17, wherein the compressed data packet includes the weights in the channel in a compressed format.

25. (canceled)

26. (canceled)

27. (canceled)

28. (canceled)

29. (canceled)

30. (canceled)

31. (canceled)

32. (canceled)

33. A method to compress data packets corresponding to a model, the method comprising:
manipulating, by executing an instruction with a processor, weights of a channel of a trained model to generate a manipulated channel;
determining, by executing an instruction with the processor, a similarity between (a) at least one of the channel or the manipulated channel and (b) a reference channel; and
when the similarity satisfies a similarity threshold, generating, by executing an instruction with the processor, a compressed data packet based on a difference between (a) the at least one of the channel or the manipulated channel and (b) the reference channel.

34. The method of claim 33, wherein the manipulating of the weights includes at least one of moving the weights within the channel, rotating the weights within the channel, inverting the weights, or flipping the weights within the channel.

35. The method of claim 33, wherein the determining of the similarity includes using a statistical similarity operation.

36. The method of claim 35, wherein the statistical similarity operation is a sum of an absolution difference operation.

37. The method of claim 33, further including selecting at least one of the channel or the manipulated channel based on the similarity that is highest, the generating of the compressed data being based on the selected channel.

38. The method of claim 33, wherein the reference channel is a previously processed channel of the trained model.

39. The method of claim 33, wherein the compressed data packet includes a value indicative of the reference channel and a value indicative of a manipulation of the manipulated weights.

40. The method of claim 33, wherein the compressed data packet includes the weights in the channel in a compressed format.

41. (canceled)

42. (canceled)

43. (canceled)

44. (canceled)

45. (canceled)

46. (canceled)

47. (canceled)

48. (canceled)
